(19) United States
(12) Patent Application Publication
(10) Pub. No.: US 2025/0237890 A1
(43) Pub. Date: Jul. 24, 2025

(54) CONTACT LENSES AND METHODS RELATING THERETO

(71) Applicant: CooperVision International Limited, Fareham (GB)

(72) Inventors: Martin WEBBER, Southampton (GB); Paul CHAMBERLAIN, Livermore, CA (US); Arthur BRADLEY, Bloomington, IN (US); Baskar ARUMUGAM, Dublin, CA (US)

(73) Assignee: CooperVision International Limited, Fareham (GB)

(21) Appl. No.: 19/026,590

(22) Filed: Jan. 17, 2025

Related U.S. Application Data
(60) Provisional application No. 63/623,542, filed on Jan. 22, 2024.

(51) Int. Cl. G02C 7/02; B29D 11/00

(52) U.S. Cl. CPC G02C 7/024; B29D 11/00038; G02C 2202/24

(57) ABSTRACT

A contact lens (401), methods of manufacturing a contact lens (401) and computer implemented methods of designing (560) a contact lens (401) are described. The lens includes a central region (405), the central region having an optical axis and a curvature having a centre of curvature that is on the optical axis, wherein the central region has a nominal distance power. The lens has an annular region (403) comprising a plurality of concentric treatment zones, wherein each treatment zone has a curvature that is greater than the curvature of the central region (405) and a centre of curvature that is not on the first optical axis, thereby resulting in a axial power that varies with radius from a minimum axial power value and a maximum axial power value, wherein the axial power varies from the nominal distance power by no more than ±1 D.

### TECHNICAL FIELD

This application claims the benefit under 35 U.S.C. § 119(e) of prior U.S. Provisional Patent Application No. 63/623,542, filed Jan. 22, 2024, which is incorporated in its entirety by reference herein.

The present disclosure relates to contact lenses. The present invention relates especially, but not exclusively, to contact lenses for slowing the progression of myopia. The present invention also relates especially, but not exclusively, to contact lenses for use by presbyopes. The present invention also relates to methods of manufacturing contact lenses, computer implemented methods of designing contact lenses and associated computer-readable storage media, computer devices and computer program products.

### BACKGROUND

Many people, including children and adults require contact lenses to correct for myopia (short-sightedness) and many adults may require lenses to correct for presbyopia (an age-related inability to accommodate and hence inability to focus on near objects).

Uncorrected myopic eyes focus incoming light from distant objects to a location in front of the retina. Consequently, the light converges towards a plane in front of the retina and then diverges towards, and is out of focus upon arrival at, the retina. Conventional lenses (e.g., spectacle lenses and contact lenses) for correcting myopia move the focus onto the retina. Spectacle lenses move the focus by causing divergence (of incoming light from distant objects before it reaches the eye. Contact lenses, when on the eye, move the focus by reducing the convergence of incoming light from distant objects.

Typical optical evaluation of a soft contact lens employs a model of the lens in air, with large refractive index changes at both front and back surfaces. When on the eye, the optical impact of the lens posterior surface is effectively eliminated because of approximate matching of the refractive indices between the lens and the cornea/tear film, and because soft contact lenses mostly conform to the anterior corneal surface of an eye. However, these two characteristics of the on-eye soft contact lens do not eliminate the effect of any optical features designed into the posterior surface of the lens.

Any optical feature incorporated into the contact lens posterior surface will affect the lens thickness, and equivalently the relative position of the anterior surface. Therefore, when the posterior lens surface has conformed to the anterior corneal surface, the relative positions of the lens anterior surface becomes relative to the cornea. For example, if a toricity is introduced into the posterior surface, it will appear on the anterior surface when the lens is placed on the cornea and thus have its effect at an air-to-lens interface.

There is therefore a challenge for how best to represent the optics of a soft contact lens in a schematic ray diagram. For example, if a contact lens has negative power, when in air it will generate diverging rays, however, when placed on the eye, the negative power will subtract from the roughly +60 D positive power of the eye, and thus the ray diagrams therefore typically show converging rays while the lens is described as having a negative power. Power values as measured in dioptres or otherwise referred to throughout the specification correspond to the dioptre values that are recorded when a contact lens or region thereof is measured off-eye, unless otherwise stated.

The internal lenses of fully presbyopic eyes do not change shape to add the required power necessary to focus on near objects. Conventional lenses (e.g., spectacle lenses and contact lenses) for correcting presbyopia include the missing extra plus power in bifocal or progressive lenses, which include regions that are optimised for near vision and regions that are optimised for distance vision. Presbyopia may be treated using bifocal or multifocal lenses, or monovision lenses (wherein different prescription are provided for each eye, one eye being provided with a distance vision lens, and one eye being provided with a near vision lens).

It was suggested several decades ago that progression of myopia in children or young people could be slowed or prevented by under-correcting, i.e., moving the focus towards but not quite onto the retina. Such an approach can be described as providing a “myopic defocus”. However, that approach necessarily results in degraded distance vision compared with the vision obtained with a lens that fully corrects for myopia. Moreover, it is now regarded as doubtful that under-correction is effective in controlling developing myopia because such an undercorrection approach will focus light from distant targets in front of the retina. However, since myopia is believed to be developing because of chronic viewing of near targets, under-correction will likely not affect the retinal images of near targets or provide a “myopic defocus” to stop the eye from growing. A more recent approach to correct for myopia is to provide lenses having either one or more regions that provide full correction of distance vision and one or more regions that under-correct, or deliberately induce, myopic defocus. It has been suggested that this approach can prevent or slow down the development or progression of myopia in children or young people, whilst providing good distance vision.

In the case of lenses having regions that provide defocus, the regions that provide full-correction of distance vision are usually referred to as distance correction regions and the regions that provide under-correction or deliberately induce myopic defocus are usually referred to as myopic defocus regions or add power regions (because the dioptric power is more positive, or less negative, than the power of the distance correction regions). A surface (typically the anterior surface) of the add power region(s) has a smaller radius of curvature than that of the distance power region(s) and therefore provides a more positive or less negative power. The add power region(s) are designed to focus incoming parallel light (i.e., light from a distance) within the eye in front of the retina (i.e., closer to the lens), whilst the distance power region(s) are designed to focus light and form an image at the retina (i.e., further away from the lens).

A known type of contact lens that reduces the progression of myopia is a dual-focus contact lens, available under the name of MISIGHT (CooperVision, Inc.). This dual-focus lens is different than bifocal or multifocal contact lenses configured to improve the vision of presbyopes, in that the dual-focus lens is configured with certain optical dimensions to enable a person who is able to accommodate to use the distance correction (i.e., the nominal distance power of the contact lens) to focus images on or close to the retina while viewing both distant objects and near objects. The treatment zones of the dual-focus lens that have an add power will always focus light more anteriorly when compared to a lens without treatment zones, and thus provide a myopically defocused image at both distant and near viewing distances.

Whilst these lenses have been found to be beneficial in preventing or slowing down the development or progression of myopia, annular add power regions can potentially give rise to unwanted visual side effects. Light that is focused by the annular add power regions in front of the retina diverges from the focus to form a defocused annulus at the retina. Under some circumstances, wearers of these lenses therefore may see a ring or ‘halo’ or ‘ghost image’ surrounding focused images that are formed on the retina, particularly for small bright objects such as streetlights and car headlights. Also, rather than using the natural accommodation of the eye (i.e., the eye's natural ability to change focal length) to bring nearby objects into focus, in theory, wearers can make use of the additional focus in front of the retina that results from the annular add power region to focus near objects; in other words, wearers can inadvertently use the lenses in the same manner as presbyopia correction lenses are used. Using the add power optics to focus near targets is undesirable for young subjects because it will reduce or eliminate the intended introduction of myopic defocus and may compromise the ability of a dual focus myopia control lens to slow myopia progression by removing the myopically defocused light.

Further lenses have been developed which can be used in the treatment of myopia, and which are designed to eliminate the halo that is observed around focused distance images. In these lenses, the annular region is configured such that no single, on-axis image is formed in front of the retina, thereby preventing such an image from being used to avoid the need for the eye to accommodate near targets. Rather, distant point light sources are imaged by the annular region to a ring-shaped focal line at a near add power focal surface, preventing a useful image from being generated at this plane. The second advantage of this type of lens is that the rays forming the ring image can overlap when reaching the retina leading to a reduced size of the blur patch and eliminating the surrounding ‘halo’ on the retina.

For treating myopia, it is recognised that it may be beneficial to provide a lens that introduces additional myopic defocus, while reducing or eliminating the risk of possible use of add power to focus at near distances and simultaneously reducing or minimizing any loss of image quality (e.g. through minimising the creation of blurring or halos) associated with the myopia control optics. For treating presbyopia, it may be beneficial to provide a lens that gives rise to an extended depth of focus.

### SUMMARY

According to a first aspect, the present disclosure provides a contact lens. The lens includes an optic zone comprising a central region, the central region having an optical axis and a curvature having a centre of curvature that is on the optical axis, wherein the central region has a nominal distance power. The optic zone comprises an annular region comprising a plurality of concentric treatment zones, wherein each treatment zone has a curvature that is greater than the curvature of the central region and has a centre of curvature that is not on the first optical axis, wherein the axial power varies with radius and varies from the nominal distance power by no more than ±1 D.

According to a second aspect, the present disclosure provides a method of manufacturing a lens. The lens may be a lens according to the first aspect. The method may comprise forming a contact lens. The contact lens includes a central region, the central region having an optical axis and a curvature having a centre of curvature that is on the optical axis, wherein the central region has a nominal distance power; and an annular region comprising a plurality of concentric treatment zones, wherein each treatment zone has a curvature that is greater than the curvature of the central region and a centre of curvature that is not on the first optical axis, thereby resulting in a axial power that varies with radius from a minimum axial power value and a maximum axial power value, wherein the radial axial power varies from the nominal distance power by no more than ±1 D.

According to a third aspect, the present disclosure provides a computer implemented method of designing a contact lens. The contact lens to be designed may be defined as a contact lens including an optic zone comprising a central region, the central region having a first optical axis, a centre of curvature that is on the first optical axis, wherein the central region has a nominal distance power; and an annular region positioned around and radially outwardly of said central region. The method may comprise the step of selecting a nominal distance power and a non-coaxial add power. The method may comprise the step of defining the central region having the selected nominal distance power and without the non-coaxial add power. The method may comprise the step of defining the annular region as a zone having the non-coaxial add power and having an axial power profile that increases radially across the zone from an axial power lower than the nominal distance power to an axial power higher than the nominal distance power. The method may comprise the step of determining an axial power profile along the width of the zone. The method may comprise the splitting step of: if the axial power exceeds a predetermined threshold relative to the nominal distance power at any point of the axial power profile along the width of the zone, splitting the zone into two further zones, each of the further zones being annular relative to the central region and concentric to each other, each of the further zones having their own axial power profile that increases radially across the zone from an axial power lower than the nominal distance power to an axial power higher than the nominal distance power. The method may comprise the step of (optionally, determining the axial power profile along the width of each zone, and) repeating the splitting step for each zone until all zones have axial power profiles that do not exceed the predetermined threshold. It may be that the method comprises the step of performing the considering and splitting step for the radially innermost zone until the entire axial power profile of the radially innermost zone falls within the predetermined threshold. Once a zone falls within the threshold, the zone immediately outwards and adjacent to the zone that falls within the threshold may be the next zone to undergo the considering and/or splitting steps (repeatedly if necessary). It may be that the method comprises the step performing the aforementioned considering and splitting step(s) for a given zone until the entire radial axial power profile of said zone falls within the predetermined threshold.

According to a fourth aspect, the present disclosure provides a method of manufacturing a contact lens, comprising designing a lens by the method of the third aspect and making the lens according to the design.

According to a fifth aspect, the present disclosure provides a computer-readable storage medium comprising a database having one or more contact lens designs stored on the database, the designs having been produced according to the method of the third aspect.

According to a sixth aspect, the present disclosure provides a computing device comprising means configured for carrying out the method of the third aspect.

According to a seventh aspect, the present disclosure provides a computer program product comprising instructions which, when the program is executed by a computer, cause the computer to carry the method of the third aspect.

According to an eighth aspect, the present disclosure provides a contact lens, the lens including an optic zone comprising: a central region, the central region having an optical axis and a curvature having a centre of curvature that is on the optical axis, wherein the central region has a nominal distance power; and an annular region comprising a plurality of concentric treatment zones, wherein each treatment zone has a curvature that is greater than the curvature of the central region and a centre of curvature that is not on the first optical axis, thereby resulting in an axial power that varies with radius from a minimum axial power value to a maximum axial power value, wherein the axial power varies from the nominal distance power by no more than ±4 D.

According to a ninth aspect, the present disclosure provides a contact lens, the lens including an optic zone comprising: a central region, the central region having an optical axis and a curvature having a centre of curvature that is on the optical axis, wherein the central region has a nominal distance power; and an annular region comprising a plurality of concentric treatment zones, wherein each treatment zone of the plurality of concentric treatment zones directly abuts an adjacent treatment zone of the plurality of concentric treatment zones, wherein at least two of the treatment zones have different radial widths, wherein each treatment zone has a curvature that is greater than the curvature of the central region and a centre of curvature that is not on the first optical axis, thereby resulting in an axial power that varies with radius from a minimum axial power value to a maximum axial power value, wherein the axial power varies from the nominal distance power by no more than ±0.5 D.

According to a tenth aspect, the present disclosure provides a contact lens, the lens including an optic zone comprising a central region, the central region having an optical axis and a curvature having a centre of curvature that is on the optical axis, and an annular region comprising a plurality of concentric treatment zones, wherein each treatment zone has a curvature that is greater than the curvature of the central region and a centre of curvature that is not on the first optical axis, thereby resulting in an axial power that varies with radius from a minimum axial power value to a maximum axial power value, wherein the axial power varies from a power by no more than ±1 D.

According to an eleventh aspect, the present disclosure provides a packaged contact lens comprising a package having a label and a contact lens within said package, wherein the contact lens includes an optic zone comprising: a central region, the central region having an optical axis and a curvature having a centre of curvature that is on the optical axis, and an annular region comprising a plurality of concentric treatment zones, wherein each treatment zone has a curvature that is greater than the curvature of the central region and a centre of curvature that is not on the first optical axis, thereby resulting in an axial power that varies with radius from a minimum axial power value to a maximum axial power value, wherein the axial power varies from a label power provided on the label by no more than ±1 D.

It will of course be appreciated that features described in relation to one aspect of the present disclosure may be incorporated into other aspects of the present disclosure. For example, the method of the disclosure may incorporate features described with reference to the apparatus of the disclosure and vice versa.

### DESCRIPTION OF THE FIGURES

Embodiments of the present invention will now be described by way of example only with reference to the accompanying schematic drawings of which:

FIG. 1A is a top view of a prior art contact lens for use in the prevention of myopia;

FIG. 1B is a side view of the contact lens of FIG. 1A;

FIG. 2A is a ray diagram for the lens of FIG. 1A;

FIG. 2B shows a light pattern at a proximal focal surface of the lens of FIG. 1A formed from a light from a distant point object, on the optical axis;

FIG. 2C shows a light pattern at a distal focal surface of the lens of FIG. 1A formed from light from a distant point object, on the optical axis;

FIG. 2D is a partial ray diagram for the lens of FIGS. 1A and 1B together with circles indicating the radii of curvature of the central distance region (dashed-dotted line) and the annular add region (dashed line) of the lens;

FIG. 3A is a top view of a different contact lens having non-coaxial optics;

FIG. 3B is a side view of the contact lens of FIG. 3A

FIG. 4A is a ray diagram for the lens of FIGS. 3A and 3B;

FIG. 4B shows a light pattern at a proximal focal surface of the lens of FIGS. 3A and 3B formed from light from a distant point object, on the optical axis;

FIG. 4C shows a light pattern at a distal focal surface of the lens of FIGS. 3A and 3B formed from light from a distant point object, on the optical axis;

FIG. 4D is a partial ray diagram for the lens of FIGS. 3A and 3B together with circles indicating the radii of curvature of the central distance region (solid line) and the annular add region (dashed line) of the contact lens.

FIG. 5A is a plot showing the variation in axial power for the lens shown in FIGS. 1A and 1B and the lens shown in FIGS. 3A and 3B;

FIG. 5B is a plot showing the variation in radial curvature power for the lens shown in FIGS. 1A and 1B and the lens shown in FIGS. 3A and 3B;

FIG. 6A is a top view of a lens according to an embodiment of the present disclosure;

FIG. 6B is a side view of the contact lens of FIG. 6A

FIG. 7 is a plot showing the variation in axial power and curvature power for the lens shown in FIGS. 6A and 6B;

FIG. 8 is a ray diagram for the lens of FIGS. 6A and 6B;

FIG. 9A is a top view of a lens according to an embodiment of the present disclosure;

FIG. 9B is a side view of the contact lens of FIG. 9A;

FIG. 10 is a plot showing the variation in axial power and curvature power for the lens shown in FIGS. 9A and 9B;

FIG. 11 is a is a flow chart showing a method of designing a lens according to an embodiment of the present disclosure, such as the lens the lens of FIGS. 9A to 10;

FIG. 12A is a plot showing the variation in axial power for a first design stage of the lens shown in FIGS. 9A and 9B;

FIG. 12B is a plot showing the variation in axial power for a second design stage of the lens shown in FIGS. 9A and 9B;

FIG. 12C is a plot showing the variation in axial power for a third design stage of the lens shown in FIGS. 9A and 9B;

FIG. 12D is a plot showing the variation in axial power for a fourth design stage of the lens shown in FIGS. 9A and 9B;

FIG. 12E is a plot showing the variation in axial power for a fifth design stage of the lens shown in FIGS. 9A and 9B;

FIG. 12F is a plot showing the variation in axial power for a sixth design stage of the lens shown in FIGS. 9A and 9B;

FIG. 12G is a plot showing the variation in axial power for a seventh design stage of the lens shown in FIGS. 9A and 9B;

FIG. 13 is a flow chart showing a method of manufacturing a lens according to an embodiment of the present disclosure;

FIG. 14 is a schematic diagram of a computing device in accordance with an embodiment of the present disclosure.

FIG. 15 is a schematic diagram of a packaged contact lens in accordance with an embodiment of the present disclosure.

### DETAILED DESCRIPTION

According to the first aspect, the present disclosure provides a contact lens. The lens includes an optic zone comprising a central region, the central region having an optical axis and a curvature having a centre of curvature that is on the optical axis, wherein the central region has a nominal distance power. The optic zone comprises an annular region comprising a plurality of concentric treatment zones, wherein each treatment zone has a curvature that is greater than the curvature of the central region and a centre of curvature that is not on the first optical axis, thereby resulting in a axial power that varies with radius from a minimum radial axial power value to a maximum radial axial power value, wherein the radial axial power varies with radius and varies from the nominal distance power by no more than ±4 D, and preferably by no more than ±1 D. A contact lens designed in such a way defines a maximum axial power range, around a nominal distance power, and allows treatment zone sizes to fluctuate such that the deviation of the radial axial power of each treatment zone does not vary from the nominal distance power by more than a certain amount. This limits the extent to which the radial axial power departs from the nominal distance power, when compared to a lens where each treatment zone has the same radial width. By staying within a certain axial range in this way, the quality of vision is increased as the step change in axial power at the boundary of each zone is reduced to within the tolerance of the distance power. As an additional advantage, such a design allows for uniform dose of treatment from the lens, for example myopia control or presbyopia control, to be provided for a wider range of pupil sizes.

The central region of the lens may have a radial curvature power that is the same as the central region's radial axial power. This is referred to herein as the base radial curvature power, the base radial axial power, or the base radial power. The nominal distance power of the central region will correspond to the labelled refractive power of the contact lens as provided on the contact lens packaging. This corresponds to a label power. The nominal distance power and/or label power will be the average axial power taken across the central region (within a margin of error of, for example ±0.125 or ±0.25 D), calculated by techniques known to the skilled person that use an aberrometer, for example a Shack-Hartmann aberrometer. The measured power of the central portion is the directly measured average refractive axial power taken across the central region. As mentioned above, the average refractive axial power taken across the central region may differ from the nominal distance power within a margin of error (e.g. a difference of ±0.125 or ±0.25 D), though it may be preferable for the average refractive axial power taken across the central region to be exactly the same as the nominal distance power. The term label power should be taken to be interchangeable with nominal distance power throughout this specification. The central region of the lens will have a base power. The base power may be the nominal distance power or the label power.

The predetermined threshold can be considered to be a tolerance that the radial axial power of the one or more of the plurality of treatment zones must stay within across their entire radial width. The predetermined threshold may be measured in dioptres. The radial axial power varies from the nominal distance power by no more than ±4 D. The radial axial power optionally varies from the nominal distance power by no more than a predetermined threshold. The predetermined threshold may be set as ±4 D. The predetermined threshold may be set as between ±0.25 D and ±0.5 D, for example it may be ±0.25 D or it may be ±0.5 D. The predetermined threshold may be set as between ±0.25 D and ±1 D. The predetermined threshold may be set as between ±0.25 D and ±2 D. The predetermined threshold may be set as between ±0.25 D and ±3 D. The predetermined threshold may be set as between ±0.25 D and ±4 D. The predetermined threshold may be set as between ±0.05 D and ±4 D, between ±0.1 D and ±4 D or between ±0.2 D and ±4 D. The predetermined threshold or tolerance value may be expressed as a percentage of the nominal distance value, for example ±5%, ±10%, ±25% or ±50% of the nominal distance value. Such an approach may improve image quality because the amount of image blur experienced by a user of the lens may scale with increasing axial power and pupil size, and thus by controlling the axial power to be within a tolerance around the nominal distance power, blurring may be reduced.

As used herein, the term contact lens refers to an ophthalmic lens that can be placed onto the anterior surface of the eye. It will be appreciated that such a contact lens will provide clinically acceptable on-eye movement and not bind to the eye or eyes of a person. The contact lens may be in the form of a corneal lens (e.g., a lens that rests on the cornea of the eye). The contact lens may be a soft contact lens, such as a hydrogel contact lens or a silicone hydrogel contact lens. The lens may be a lens for use in preventing or slowing the development or progression of myopia. The lens may be a lens for use in providing an extended depth of focus to a presbyopic eye.

A contact lens according to the present disclosure comprises an optic zone. The optic zone encompasses the parts of the lens that have optical functionality. The optic zone is configured to be positioned over the pupil of an eye when in use. For contact lenses according to the present disclosure, the optic zone comprises a central region, and an annular region that surrounds the central region. The optic zone may be surrounded by a peripheral zone. The peripheral zone is not part of the optic zone, but sits outside the optic zone and above the iris when the lens is worn, and it provides mechanical functions, for example, increasing the size of the lens thereby making the lens easier to handle, providing ballasting to prevent rotation of the lens, and/or providing a shaped region that improves comfort for the lens wearer. The peripheral zone may extend to the edge of the contact lens.

A contact lens according to an embodiment of the disclosure may include a ballast to orient the lens when positioned on the eye of a wearer. Embodiments of the disclosure incorporating a ballast into the contact lens will, when placed on the eye of a wearer, rotate under the action of the wearer's eyelid to a pre-determined angle of repose; for example, the ballast may be a wedge and the rotation may result from the action of the eyelid on the wedge. It is well-known in the art to ballast a contact lens to orient a contact lens; for example, toric contact lenses are ballasted to orient the lens so that the orthogonal cylindrical corrections provided by the lens align correctly for the astigmatism of the wearer's eye.

The contact lens may be substantially circular in shape and have a diameter from about 4 mm to about 20 mm. The optic zone may be substantially circular in shape and may have a diameter from about 2 mm to about 10 mm. In some embodiments, the contact lens has a diameter from 13 mm to 15 mm, and the optic zone has a diameter from 7 mm to 9 mm.

The optical axis may lie along the centreline of the lens. The central region may focus light from a distant point object, on the optical axis, to a spot on the optical axis at a distal focal surface.

The central region may have a substantially circular shape. The central region may have a substantially oval or elliptical shape. The central region may have a small diameter of less than 2.0 mm. The central region may have a diameter of less than 1 mm, less than 0.5 mm, or less than 0.25 mm. If the central region is substantially elliptical or oval in shape, the maximum diameter may be less than 2.0 mm, less than 1.0 mm or less than 0.5 mm, or less than 0.25 mm.

The annular region may extend radially outwards from a perimeter of the central region. The perimeter of the central region may define a boundary between the central region and the annular region, and the annular region may therefore be adjacent to the central region. The annular region may be a substantially annular region that surrounds the optic zone. It may have a substantially circular shape or a substantially elliptical shape. It may fully surround the optic zone. It may partially surround the optical zone.

The annular region comprises a plurality of concentric treatment zones. A treatment zone is a region of a contact lens that is arranged to provide a stimulus that slows or prevents the development of myopia. The annular region may comprise between 2 and 10 concentric treatment zones, optionally between 4 and 8 concentric treatment zones, optionally 4 or 5 treatment zones. Each treatment zone may have a radial width of between about 0.05 and 2.5 mm, optionally between about 0.1 and 1.2 mm, optionally between about 0.3 and 1.0 mm. Each treatment zone may have a radial width of between 0.1 and 2.5 mm. Each treatment zone may have the same radial width. At least two of the treatment zones may have different radial widths. Each of the treatment zones may have a radial width that is different to the radial width of each of the other treatment zones. By radial width, what is meant is the width measured across the treatment zone, measured radially outwards from the outer perimeter of the central region.

Each treatment zone may directly abut an adjacent treatment zone, i.e., an outer perimeter of a first treatment zone may define a boundary between the first treatment zone and a second treatment zone. The second treatment zone may therefore be adjacent to the first treatment zone.

Both axial and curvature powers of a lens are defined along a given direction of the lens. For ophthalmic lenses according to embodiments of the present disclosure, the radial axial power and radial curvature power vary along a direction extending radially outwards from the optical axis of the lens i.e. in a meridional direction. The circumferential axial power and circumferential curvature power vary along a direction that is perpendicular to that radial direction i.e. in an azimuthal direction of the lens. Whenever the term “axial power” or “curvature power” is used unqualified in the specification, such terms refer to radial axial and radial curvature powers.

As used herein, axial power (also known as sagittal power) at a point on the lens surface is used to describe the optical power of a lens obtained using the position at which rays passing through the lens surface at that point cross the optical axis of the lens. References to the “power” of a lens are generally referring to the axial power, unless the context implies otherwise. As the skilled person will understand, axial power can be calculated from the slope (i.e. first derivative) of a wavefront that has passed through the lens (for that reason axial power is also known as slope-based power) and curvature power can be calculated from the second derivative of a wavefront that has passed through the lens. A wavefront can be measured using a Shack-Hartmann wavefront sensor.

While the values of axial power and curvature power (i.e. the power provided by the radius of curvature at a point on the lens surface) can be identical or similar for low aberration optics (e.g. single vision lenses), the axial and the curvature powers can be very different for some recently developed myopia-control lenses that employ “non-coaxial optics”. These lenses have surface regions that focus light from an on-axis source onto regions displaced from the optical axis, so that the distance at which the local ray bundles come to a focus can be very different from the distance at which they cross the optical axis of the larger, composite lens. For these types of lenses, the distinction between axial (sagittal) and curvature (local) power becomes important. With non-coaxial optics (i.e. where at least some parts of the lens focus incoming light rays that are parallel to the optical axis to regions that are not on the optical axis), a description of the curvature power alone or the axial power alone does not provide a complete description of the optics. Adjacent regions of a lens can have the same curvature power but differing axial powers (rays from each region cross the optical axis at different distances from the local focal distance and from each other). For a lens that includes non-coaxial lenslets, for example, the resulting axial and curvature power values may differ significantly: a curvature power map of such a lens shows the consistent add power of each lenslet, but an axial power map reveals the varying axial power of the lenslet with radial distance i.e. the distance of the point on the lens surface from the optical axis in a direction normal to the optical axis.

An eye will typically suffer from spherical aberration. Spherical aberration of an eye may be spherical aberration of the lens of an eye, and/or spherical aberration of the retina. Spherical aberration causes light rays passing from through the periphery of an eye to focus to a different location, compared to light rays passing through the centre of an eye.

Each treatment zone may be radially tilted relative to the central zone and optionally tilted such that each treatment zone is circularly symmetric. As a result of tilting away from the axis, each treatment zone has a radial axial power profile that increases with increasing radial distance from the optical axis. The radial axial power profile of the central region may be approximately flat. Alternatively, the radial axial power profile across the central region may have a curved profile. The radial axial power profile across the central region may have a quadratic or parabolic shape. As used herein, the tilting of the treatment zones means radial tilting rather than lateral tilting. Thus, for example, in a radial cross section of the lens, an outer end of an arc defining the anterior surface of the first annular region may be displaced above (or below) its position in a corresponding un-tilted treatment zone. Correspondingly, in three dimensions, a circumferential boundary (formed by the ends of the radial arcs) of the treatment zones may be displaced above or below its position in a corresponding un-tilted treatment zone. In practice, the tilting may be embodied in the optical design of an anterior surface of the treatment zones of the lens. The tilting may alternatively be embodied in the optical design of a posterior surface of the treatment zones of the lens, or embodied in the optical design of both anterior and posterior surfaces of the treatment zones of the lens. Radially tilting a treatment zone relative to the central zone shifts the centre of curvature of that treatment zone away from the optical axis. A larger radial tilt relative to the central region will give rise to a greater shift in the centre of curvature of the treatment zone, and a steeper gradient of the radial axial (sagittal) power profile. Light rays from a distant point object, on the optical axis passing through a radially tilted treatment zone will not focus towards a single point on the optical axis, but instead, will focus towards a ring of off-axis points. For an annular treatment zone having a constant radial axial power, light rays from a distant point object, on the optical axis, passing through a radially tilted treatment zone will form an annular ring at a focal surface. The diameter of the annular ring will depend, in part, on the tilt of the treatment zone relative to the central region. The diameter of the annular ring will also be dependent upon the radial distance of the treatment zone from the optical axis, and the radial add power of the treatment zone. Wherever a “power profile” is referred to herein, it is to be assumed the power profile is the power profile in the radial direction (e.g. the “radial axial power profile”) unless otherwise specified.

In a lens having concentric annular regions that provide focusing, light can be considered to be “focused” by the annular regions in two different ways.

In a first form of focusing, light is focused by the local curvature of the annular region. Considering a transverse 2 D cross-section through the lens, and in the approximation of geometric optics, adjacent rays passing through the radial width of the annular region (i.e. through a single “side” of the annulus, i.e. through a portion of a radius between the inner circumference of the annular region and the outer circumference of the annular region) from a distant source are focused by the local curvature of the annular region to a point; and the points from each of the radial widths around the annulus together form a ring of focal points around the optic axis of the lens. This local focusing, resulting from the local curvature within the radial width of the annular region, is referred to herein as focusing and the surface containing the focal ring is referred to as a focal surface. The curvature power of the annular region depends on the degree of (local) focusing.

The terms focal surface, as used herein, does not refer to a physical surface, but to a surface that could be drawn through points where light from distant objects would be focused or reach a locally minimal spot size. The eye focuses light onto the retina, which is curved, and in a perfectly focused eye, the curvature of the surface would match the curvature of the retina, therefore the eye does not focus light onto a flat mathematical plane. However, in the art, the curved surface of the retina is commonly referred to as a plane.

An axial power profile may be the trace that represents the variation in axial power across a treatment zone and/or central region. Said trace may have characteristic gradients, and/or start and end points when considering axial power in relation to radial width of a given zone or end point.

In embodiments of the present disclosure, at least two of the treatment zones may have different axial power profiles. At the boundary between the central zone and a first, innermost annular zone there may be a change in gradient of the axial power profile. At the boundary between adjacent treatment zones there may be a change in gradient of the radial axial power profile. Alternatively, each of the plurality of concentric treatment zones may have a different axial power profile. Alternatively, each treatment zones may have substantially the same axial power profile, and/or a similar axial power profile gradient.

The difference between the maximum and/or minimum axial power and the nominal distance power may be the same for each treatment zone. Alternatively, the difference between the maximum and/or minimum axial power and the nominal distance power may be different for each treatment zone. Alternatively, the maximum and/or minimum axial power of at least one of the treatment zones may differ from the nominal distance power by a value between ±0.1 D and ±4 D, and preferably by a value of between ±0.25 D and ±1 D.

Alternatively, the difference between the maximum and/or minimum axial power and the nominal distance power for at least one treatment zone differs from the nominal distance power by an amount substantially equal to the predetermined threshold. Alternatively, the difference between the maximum and/or minimum axial power and the nominal distance power for at least one of the treatment zones may be between ±0.1 D and ±4 D, and preferably ±1 D (and/or the predetermined threshold). An improved lens design for a given distance power can be achieved through providing a difference in axial power by a number of diopters between ±0.1 D and ±4 D and/or the predetermined threshold, such that the fewest number of zones as the maximum divergence from the nominal distance power allowed can be utilised for each treatment zone, resulting in a lens that is simpler to manufacture as it has fewer treatment zones.

The axial power profile of each treatment zone may be an average gradient of the axial power across the width of the treatment zone. The axial power profile of each treatment zone may have a gradient of between about 0.5 D/mm and about 20.0 D/mm, optionally between about 0.5 D/mm and about 10.0 D/mm, more optionally between about 1.0 D/mm and about 6.0 D/mm. The axial power profile of each treatment zone may have a gradient of between about 0.5 D/mm and 6.0 D/mm. A first, innermost treatment zone (i.e., closest to the central region), may have a first axial power profile gradient. A second, adjacent treatment zone may have a second, different axial power profile gradient, and a third treatment zone adjacent to the second treatment zone may have the same axial power profile gradient as the first treatment zone.

Radially tilting a treatment zone relative to the central region alters the axial power profile of that treatment zone, as this is a function of the first derivative of the wavefront, but it will not alter the radial curvature power of that treatment zone, which is a function of the second derivative of the wavefront.

For lenses according to embodiments of the present disclosure, the central region may have a substantially flat axial power profile. The axial power of the central region will be equal to the radial curvature power of the central region. The axial power across the central region may have curved profile. The axial power profile across the central region may have a parabolic or quadratic shape.

For lenses used in the treatment of myopia, the nominal distance power of the lens will be negative or close to zero. The nominal distance power may be between +0.5 diopters (D) and −15.0 D. The nominal distance power may be between −0.25 D to −15.0 D.

For lenses according to embodiments of the present disclosure, the central region may have a distance power that is approximately equal to the nominal distance power. The central region may have a distance power that is less than (i.e., less positive, or more negative) than the nominal distance power. The average axial power across the central region may be approximately equal to the nominal distance power, or may be less than (i.e., less positive, or more negative) than the nominal distance power. The average axial power across the central region may be more than (i.e., more positive, or less negative) than the nominal distance power.

For lenses according to embodiments of the present disclosure, at least one treatment zone has a radial curvature power that is greater than the nominal distance power of the lens. Each treatment zone may have a radial curvature power that is greater than the nominal distance power of the lens. Each treatment zone may therefore provide a radial curvature add power. Hereafter, the difference in radial curvature power of each treatment zone and the nominal distance power may be referred to as a radial curvature add power, or a curvature add power. Each treatment zone may have a radial curvature power that is the same as that of each other treatment zone. Each treatment zone may have a radial curvature power that is different to that of each other treatment zone.

Increasing the radius of curvature of a treatment zone will reduce the radial curvature power of that treatment zone, as this is a function of the second derivative of the wavefront. The radial curvature power of each treatment zone is determined by the curvature of at least one surface of the annular region. The radial curvature power of each treatment zone may result from the curvature of an anterior surface and/or a posterior surface of the lens. Each treatment zone may have a greater curvature, or a smaller radius of curvature, than the central region. The anterior surface of each treatment zone may have a greater curvature, or smaller radius of curvature than the curvature of the central region. Alternatively, or additionally, the posterior surface of each treatment zone may have a greater curvature than the curvature of the central region. Alternatively, or additionally, the posterior surface of each treatment zone may comprise substantially flat regions that cause each treatment zone to form on the anterior surface when the contact lens is placed on the eye, such that each treatment zone may have a greater curvature, or smaller radius of curvature than the curvature of the central region.

The nominal distance power of the lens may be positive, and each treatment zone may have a curvature power that is more positive than the nominal distance power. In this case, light from a distant point object, on the optical axis passing through each treatment zone will be focused towards an add power focal surface that is closer to the lens than the distal focal surface.

The nominal distance power of the lens may be negative, and each treatment zone may have a curvature power that is less negative than the nominal distance power, or each treatment zone may have a positive curvature power. Considering the lens positioned on the cornea, if the curvature power of a treatment zone is less negative than the nominal distance power, light from a distant point object, on the optical axis, passing through that treatment zone will be focused towards an add power focal surface that is more anterior in the eye than the distal focal surface.

For lenses according to embodiments of the present disclosure, the radial curvature power of the central region may be equal to, or approximately equal to, the nominal distance power. In this case, when the lens is on an eye, light from a light from a distant point object, on the optical axis, passing through the central region may be focused to a spot on the first optical axis at a distal focal surface.

A first, innermost treatment zone has a first radial curvature power value that is greater (i.e., more positive, or less negative) than the nominal distance power. When the lens is positioned on an eye, a first, innermost, treatment zone may focus light from a distant point object, on the optical axis, towards a focal surface that is closer to the lens than the distal focal surface.

Each treatment zone may have a different radial curvature add power. The radial curvature power a first, innermost treatment zone may have a first value, and the radial curvature power of an adjacent, second treatment zone, positioned at a greater radial distance from the first optical axis may have a second, greater value. This may improve vision for a lens wearer. Alternatively, a second treatment zone, positioned at a greater radial distance from the first optical axis may have a second, smaller value. A first, innermost treatment zone may have a radial curvature add power of between +0.5 D and +20.0 D, optionally between about +2.0 and +10.0 D, more optionally between about +1.0 D and +5.0 D. A second, adjacent treatment zone may have a greater radial curvature add power of between +0.5 D and +20.0 D, optionally between +4.0 D and +20.0 D. The radial curvature add power of the treatment zones may alternate between a high radial curvature add power value, and a low radial curvature add power value, the high radial curvature power being greater than the nominal distance power of the lens. The high radial curvature add power value and the low radial curvature add power value may both be greater than the nominal distance power of the lens. The high radial curvature add power may be between +4.0 D and +20.0 D. The low radial curvature add power may be between +1.0 D and +5.0 D. For a lens on an eye, high radial curvature add power treatment zones will focus light from a distant point object, on the optical axis, towards the near focal surface that is closer to the lens than the distal focal surface. Low radial curvature add power treatment zones may focus light from a distant point object, on the optical axis, towards a middle focal surface that lies in between the near focal surface and the distal focal surface.

Alternatively, each treatment zone may have the same radial curvature add power. The radial curvature add power of each treatment zone may be greater than the nominal distance power. The curvature power of at least one treatment zone of the plurality of concentric treatment zones may be substantially constant across the radial width of the at least one treatment zone. The curvature power of each of the treatment zones of the plurality of concentric treatment zones may be substantially constant across the radial width of each treatment zone. The curvature power of each of the concentric treatment zones may be substantially constant across the radial width of every treatment zone and substantially the same for each treatment zone.

In some embodiments of the invention, the nominal distance power of the lens may be greater than the radial curvature power of the central region.

At the boundaries between adjacent treatment zones, there may be a sharp, discontinuous increase or decrease in radial curvature power, depending upon the relative radial curvature add powers of the treatment zones.

At the boundaries between adjacent treatment zones, there may be a sharp, discontinuous increase or decrease in axial power. At a point halfway across the radial width of a first, innermost treatment zone, the axial power may approximately equal the nominal distance power of the lens. At a point halfway across the radial width of any or all of the treatment zones, the axial power may approximately equal the nominal distance power of the lens.

The axial power may be the same at a point halfway across the width of each treatment zone. At a point halfway across the radial width of an innermost of the treatment zones, the axial power of that treatment zone may be substantially equal to the nominal distance power of the lens. At a point halfway across the radial width of each of the treatment zones, the axial power of each treatment zone may substantially match the nominal distance power of the lens.

At any of the boundaries between adjacent treatment zones there may be a sharp increase in axial power. The axial power of each treatment zone will increase with increasing radius from the central zone. The axial power at a point halfway across the radial width of each treatment zone will be less than the radial curvature power of that treatment zone. For at least one treatment zone the axial power, at the radially innermost portion of the treatment zone, may be below the nominal distance power and the axial power, at the radially outermost portion of the treatment zone, is higher than the nominal distance power. In some embodiments of the invention, for all treatment zones, the axial power, at the radially innermost portion of the treatment zone, is below the nominal distance power and the axial power, at the radially outermost portion of the treatment zone, is higher than the nominal distance power. Alternatively, the axial power at least one of the treatment zones may be substantially zero.

Each treatment zone may have a mean or average axial power value corresponding to the average axial power across the radial width of the treatment zone (per unit mm in radial width). At least two of the treatment zones may have different average axial power values when compared to each other. Optionally, each of the concentric treatment zones have different average axial power values when compared to each other. Alternatively, or additionally, at least two of the treatment zones have substantially the same average axial power value. Optionally, each of the concentric treatment zones may have substantially the same average axial power values when compared to each other.

The contact lens may comprise an elastomer material, a silicone elastomer material, a hydrogel material, or a silicone hydrogel material, or combinations thereof. As understood in the field of contact lenses, a hydrogel is a material that retains water in an equilibrium state and is free of a silicone-containing chemical. A silicone hydrogel is a hydrogel that includes a silicone-containing chemical. Hydrogel materials and silicone hydrogel materials, as described in the context of the present disclosure, have an equilibrium water content (EWC) of at least 10% to about 90% (wt/wt). In some embodiments, the hydrogel material or silicone hydrogel material has an EWC from about 30% to about 70% (wt/wt). In comparison, a silicone elastomer material, as described in the context of the present disclosure, has a water content from about 0% to less than 10% (wt/wt). Typically, the silicone elastomer materials used with the present methods or apparatus have a water content from 0.1% to 3% (wt/wt). Examples of suitable lens formulations include those having the following United States Adopted Names (USANs): methafilcon A, ocufilcon A, ocufilcon B, ocufilcon C, ocufilcon D, omafilcon A, omafilcon B, comfilcon A, enfilcon A, stenfilcon A, fanfilcon A, etafilcon A, senofilcon A, senofilcon B, senofilcon C, narafilcon A, narafilcon B, balafilcon A, samfilcon A, lotrafilcon A, lotrafilcon B, somofilcon A, riofilcon A, delefilcon A, verofilcon A, kalifilcon A, and the like.

Alternatively, the lens may comprise, consist essentially of, or consist of a silicone elastomer material. For example, the lens may comprise, consist essentially of, or consist of a silicone elastomer material having a Shore A hardness from 3 to 50. The shore A hardness can be determined using conventional methods, as understood by persons of ordinary skill in the art (for example, using a method DIN 53505). Other silicone elastomer materials can be obtained from NuSil Technology or Dow Chemical Company, for example.

According to the second aspect, the present disclosure provides a method of manufacturing a lens. The lens may be according to the lens of the first aspect. The method may comprise forming a contact lens. The contact lens includes a central region, the central region having an optical axis and a curvature having a centre of curvature that is on the optical axis, wherein the central region has a nominal distance power; and an annular region comprising a plurality of concentric treatment zones, wherein each treatment zone has a curvature that is greater than the curvature of the central region and has a centre of curvature that is not on the first optical axis, thereby resulting in an axial power that varies with radius from a minimum axial power value and a maximum axial power value, wherein the axial power varies from the nominal distance power by no more than ±4 D.

The lens may include any of the features set out above in respect of the first aspect of the invention.

The method of manufacturing may comprise forming a female mold member with a concave lens forming surface and a male mold member with a convex lens forming surface. The method may comprise filling a gap between the female and male mold members with bulk lens material. The method may further comprise curing the bulk lens material to forms the lens. The contact lens may be a formed using a lathing process. The lens can be formed by cast molding processes, spin cast molding processes, or lathing processes, or a combination thereof. As understood by persons skilled in the art, cast molding refers to the molding of a lens by placing a lens forming material between a female mold member having a concave lens member forming surface, and a male mold member having a convex lens member forming surface.

According to the third aspect, the present disclosure provides a computer implemented method of designing a contact lens. The contact lens to be designed may be defined as a contact lens including an optic zone comprising a central region, the central region having a first optical axis, a centre of curvature that is on the first optical axis, wherein the central region has a nominal distance power; and an annular region positioned around said central region. The method may comprise the step of: selecting a nominal distance power and a non-coaxial add power. The method may comprise the step of defining the central region having the selected nominal distance power and without the non-coaxial add power. The method may comprise the step of defining the annular region as a zone having the non-coaxial add power and having an axial power profile that increases radially across the zone from an axial power lower than the nominal distance power to an axial power higher than the nominal distance power. The method may comprise the step of determining the axial power profile along the width of the zone. The method may comprise the splitting step of: if the axial power exceeds a predetermined threshold relative to the nominal distance power at any point of the axial power profile along the width of the zone, splitting the zone into two further zones, each of the further zones being annular relative to the central region and concentric to each other, each of the further zones having their own axial power profile that increases radially across the zone from an axial power lower than the nominal distance power to an axial power higher than the nominal distance power. The method may comprise the step of (optionally, determining the axial power profile along the width of each zone, and) repeating the aforementioned splitting step for each zone until all zones have axial power profiles that do not exceed the predetermined threshold.

The predetermined threshold may be set as between ±0.25 D and ±0.5 D. The predetermined threshold may be set as between ±0.25 D and ±1 D. The predetermined threshold may be set as between ±0.25 D and ±0.4 D. The predetermined threshold may be set as between ±0.1 D and ±0.5 D. The predetermined threshold may be set as between ±0.1 D and ±4 D. The predetermined threshold may be set as between ±0.75 D and ±0.5 D. The predetermined threshold may be set as between ±0.1 D and ±0.4 D. The predetermined threshold may be set as between ±0.1 D and ±0.25 D. The predetermined threshold may be set as between ±0.25 D and ±3 D. The predetermined threshold may be set as between ±0.25 D and ±3 D. The predetermined threshold can be considered to be a tolerance, relative to the nominal distance power, that the axial power of the one or more of the plurality of treatment zones must stay within across the entire radial width of the zone. Such an approach may improve image quality because the amount of image blur experienced by a user of the lens may scale with increasing axial power and pupil size, and thus by controlling the axial power to be within a tolerance around the nominal distance power, blurring may be reduced.

It may be that the splitting step splits the zone at a midpoint of their radial width. It may be that they may split the zone at a point different to its radial midpoint. It may be that each of the treatment zones may be split at different relative points along their radial width (e.g., a first zone may be split at a point 25% along its radial width, whereas a second zone may be split at a point 75% along its radial width).

It may be that the method further comprises defining a minimum zone width, such that if any splitting step would cause a zone to be split to below the minimum zone width, instead of performing the splitting step, performing a step of altering the gradient of the axial power profile such that the axial power stays within the predetermined threshold across the entire radial width of the zone. Such a step ensures that overly small treatment zones, which may be difficult or otherwise overly onerous to manufacture.

Alternatively, the method may comprise defining a minimum zone width, wherein, if any splitting step would cause a zone to be split to below the minimum zone width, instead of performing the splitting step, performing a step of increasing the predetermined threshold to define an increased predetermined threshold, such that the axial power stays within the increased predetermined threshold across the entire radial width of the zone such that the axial power stays within the increased predetermined threshold across the entire radial width of the zone.

The method may further comprise the step of storing the resultant contact lens design in a database. This allows contact lens designs made by the method to be easily stored, recalled, and compared.

According to the fourth aspect, the present disclosure provides a method of manufacturing a contact lens, comprising designing a lens by the method of the third aspect and making the lens according to the design.

According to the fifth aspect, the present disclosure provides a computer-readable storage medium comprising a database having one or more contact lens designs stored on the database, the designs having been produced according to the method of the third aspect.

According to the sixth aspect, the present disclosure provides a computing device comprising means configured for carrying out the method of the third aspect.

According to the seventh aspect, the present disclosure provides a computer program product comprising instructions which, when the program is executed by a computer, cause the computer to carry the method of the third aspect.

According to the eighth aspect, the present disclosure provides a contact lens, the lens including an optic zone comprising: a central region, the central region having an optical axis and a curvature having a centre of curvature that is on the optical axis, wherein the central region has a nominal distance power; and an annular region comprising a plurality of concentric treatment zones, wherein each treatment zone has a curvature that is greater than the curvature of the central region and a centre of curvature that is not on the first optical axis, thereby resulting in an axial power that varies with radius from a minimum axial power value to a maximum axial power value, wherein the axial power varies from the nominal distance power by no more than ±4 D.

According to the ninth aspect, the present disclosure provides a contact lens, the lens including an optic zone comprising: a central region, the central region having an optical axis and a curvature having a centre of curvature that is on the optical axis, wherein the central region has a nominal distance power; and an annular region comprising a plurality of concentric treatment zones, wherein each treatment zone of the plurality of concentric treatment zones directly abuts an adjacent treatment zone of the plurality of concentric treatment zones, wherein at least two of the treatment zones have different radial widths, wherein each treatment zone has a curvature that is greater than the curvature of the central region and a centre of curvature that is not on the first optical axis, thereby resulting in an axial power that varies with radius from a minimum axial power value to a maximum axial power value, wherein the axial power varies from the nominal distance power by no more than ±0.5 D.

According to a tenth aspect of the invention, the present disclosure provides a contact lens, the lens including an optic zone comprising a central region, the central region having an optical axis and a curvature having a centre of curvature that is on the optical axis, and an annular region comprising a plurality of concentric treatment zones, wherein each treatment zone has a curvature that is greater than the curvature of the central region and a centre of curvature that is not on the first optical axis, thereby resulting in an axial power that varies with radius from a minimum axial power value to a maximum axial power value, wherein the axial power varies from a power by no more than ±1 D.

The power about which the axial power varies may be the average axial power across the central region or the nominal distance power or the label power. The power about which the axial power varies may be a target power that is independent from any measured power of the central region.

According to an eleventh aspect of the invention, the present disclosure provides a packaged contact lens comprising a package having a label and a contact lens within said package, wherein the contact lens includes an optic zone comprising: a central region, the central region having an optical axis and a curvature having a centre of curvature that is on the optical axis, and an annular region comprising a plurality of concentric treatment zones, wherein each treatment zone has a curvature that is greater than the curvature of the central region and a centre of curvature that is not on the first optical axis, thereby resulting in an axial power that varies with radius from a minimum axial power value to a maximum axial power value, wherein the axial power varies from a label power provided on the label by no more than ±1 D.

The package may be a blister pack. The blister pack may have a bowl-like lens recess for receiving the contact lens. The bowl-like lens recess may take the form of a truncated circle. The blister pack may comprise a film and/or foil to seal the contact lens within the bowl-like lens recess. The label may be printed or affixed to the film.

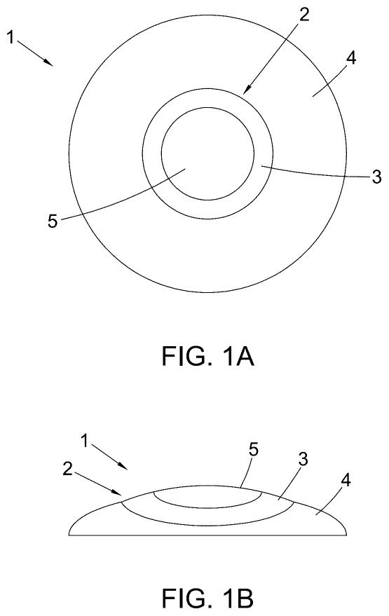

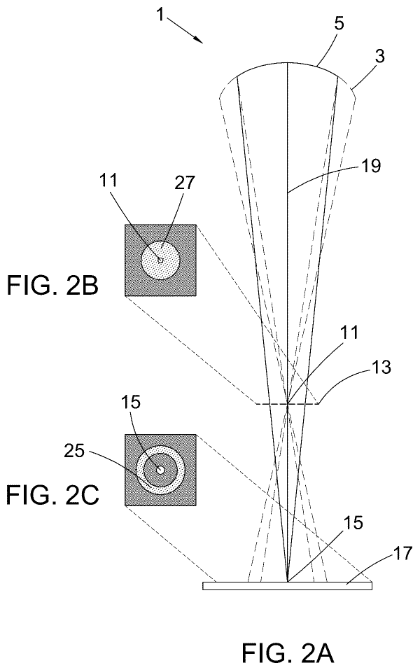

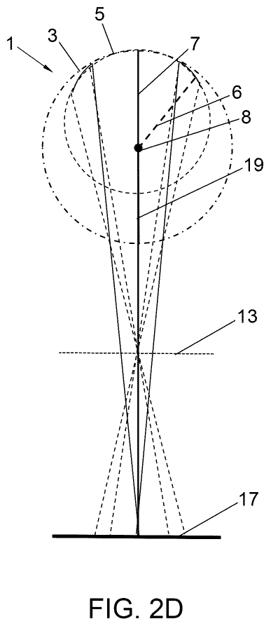

FIG. 1A and FIG. 1B show lens 1 for use in the slowing progression of myopia (e.g., myopia control). The lens 1 comprises an optic zone 2, which approximately covers the pupil, and a peripheral zone 4 that sits over the iris. The peripheral zone 4 provides mechanical functions, including increasing the size of the lens thereby making the lens 1 easier to handle, providing ballasting to prevent rotation of the lens 1, and providing a shaped region that improves comfort for the lens 1 wearer. The optic zone 2 provides the optical functionality of the lens 1, and the optic zone 2 comprises an annular region 3 and a central region 5. For this lens 1, the central region 5 has a base curvature power that corresponds to the distance power of the lens 1. The annular region 3 has a greater radial curvature power than the base curvature power of the central region 5. FIG. 2A is a schematic ray diagram showing how the lens 1 of FIGS. 1A-1B focuses light when the lens is positioned on an eye. The focus 11 of the annular region 3 lies on a proximal focal surface 13, and the focus 15 for the central region 5 lies on a distal focal surface 17, which is further away from the posterior surface of the lens 1. The centre of curvature 8 of the central region 5 lies on a first optical axis 19 and the centre of curvature of the annular region 3 lies on the first optical axis 19, as shown in FIG. 2D. The focus 11 of the annular region 3 and the focus 15 of the central region 5 share a common optical axis 19. As shown in FIGS. 2A and 2C, for a point source at infinity, light rays focused by the central region 5 form a focused image 15 at the distal focal surface 17. As shown in FIGS. 2A and 2B, light rays focused by the central region 5 also produce an unfocused blur spot 27 at the proximal focal surface 13.

As shown in FIGS. 2A and 2B, light rays focused from a distant point object, on the optical axis, by the annular region 3 form a focused, on-axis image 11 at the proximal focal surface 13. Light rays focused by the annular region 3 diverge after the proximal focal surface 13, and, as shown in FIGS. 2A and 2C, the diverging light rays produce an unfocused annulus 25 at the distal focal surface 17. As discussed above, the unfocused annulus 25 image may result in wearers of the lens seeing a ‘halo’ around focused distance images. The annular region 3 of the lens 1 of FIGS. 1A-2C may be referred to as a co-axial annular region 3, because light rays from a distant point object, on the optical axis, passing through the annular region 3 are focused to a spot on the optical axis 19.

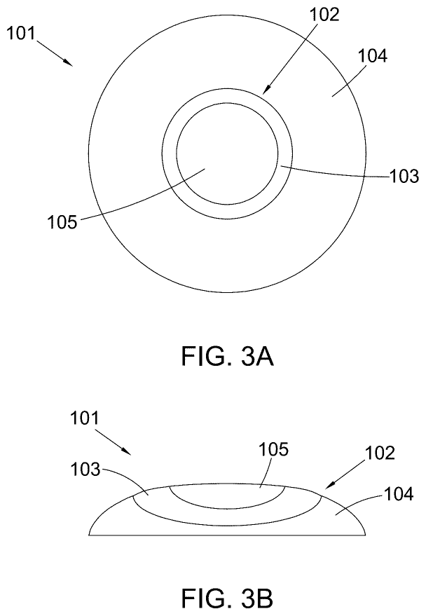

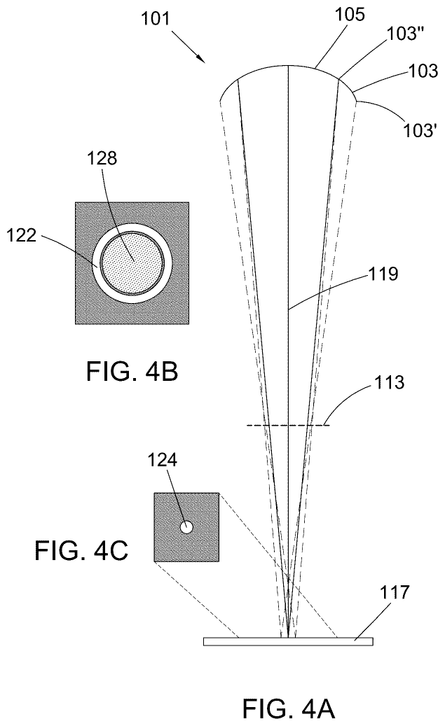

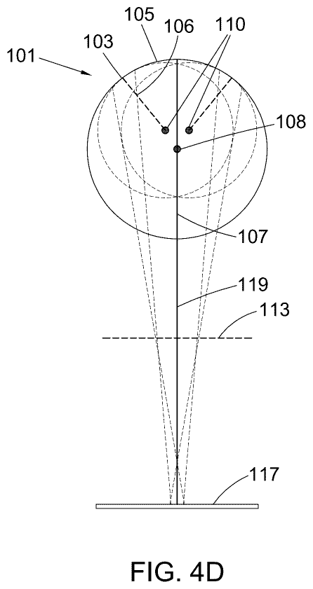

FIGS. 3A and 3B respectively show a schematic top view and side view of another known lens 101. Similar to the lens 1 shown in FIGS. 1A and 1B the lens 101 comprises an optic zone 102 and a peripheral zone 104 surrounding the optic zone 102. The optic zone 102 comprises a central region 105 and a first annular region 103 that surrounds the central region 105. As shown in FIGS. 4A and 4D, the central region 105 has a centre of curvature that is on an optical axis 119. The first annular region 103 is radially tilted relative to the central region 105, and the first annular region 103 has an off-axis centre of curvature that is a first distance from the optical axis 119. The anterior surface of the first annular region 103 has a greater curvature than the anterior surface of the central region 105, and therefore provides a greater curvature power than the base curvature power of the central region 105. FIG. 4D is a partial ray diagram for the lens 101 of FIGS. 3A-B, when the lens 101 is positioned on an eye, together with circles indicating schematically the radii of curvature of the central distance region (solid circle) and the annular add region (dashed circle) of the lens 101. As shown in FIG. 4D, the anterior surface of the central region 105 defines a portion of a surface of a sphere of larger radius 107. The centre of curvature 108 of the central region 105 lies on a first optical axis 119. The anterior surface of the annular region 103 defines a curved annular surface with smaller radius 106.

FIGS. 4A and 4C shows a light pattern formed from light from a distant point object, on the optical axis, at a distal focal surface 117 of the lens of FIGS. 3A-B formed when the lens 101 is positioned on an eye. At the distal focal surface 117 light rays passing through the central region 105 are focused. Light rays passing through the midpoints of the width of the annular region 103 converge at the same point as the light rays passing though the central region 105 are focused. The annular region 103 acts as an optical beam stop, which leads to a small spot 133 of light at the distal focal surface 117.

FIG. 4B shows a light pattern at a proximal focal surface 113 of the lens 101 of FIGS. 3A-B formed from a distant point object, on the optical axis, when the lens 101 is positioned on an eye. A single image is not formed at the proximal focal surface 113. At the proximal focal surface 113, for a point source at infinity, light rays passing through the central region 105 generate a blur circle 128. However, light rays from a distant point object, on the optical axis, passing through the annular region 103 generate an annular ring 122, as shown in FIG. 4B, which surrounds the blur circle 128. FIG. 4B shows the light pattern generated for a distant point object, on the optical axis.

In contrast to the ray diagram 1 of FIGS. 1A and 1B, the ray diagram 101 of FIGS. 3A and 3B does not show a single image or an on-axis image at the proximal focal surface 113 that could be used to avoid the need for the eye to accommodate for near objects. For an extended object at distance, the image formed at the proximal focal surface 113 is a convolution of (i) the focused image of the extended object that would be obtained with a conventional lens having the optical power of the annular region 103 and (ii) an optical transfer function representing the optical effect of the annular region 103.

At the proximal focal surface 113, for a distant on-axis point source, light rays passing through the central region 105 generate a blur disc 128 (shown in FIG. 4B), similar to the lens 1 of FIGS. 1A and 1B. However, light rays from a distant point source passing through the annular region 103 generate a focused annulus 122 (shown in FIG. 4B), which surrounds the blur disc 128.

Light rays passing through the central region 105 are focused at the distal focal surface 117. The annular region 103 acts as an optical beam stop, which leads to a small spot size of light 124 (shown in FIG. 4C) at the distal focal surface 117. In contrast to the lens 1 of FIGS. 1A and 1i, an annulus or ‘halo’ effect does not occur at the distal focal surface 117 or is greatly reduced.

The annular region 103 radial curvature power is provided by a radius of curvature of the annular region 103, which is smaller than the radius of curvature of the central region 105. However, in contrast to the lens 1 of FIGS. 1A and 1B, the curvature 110 of the annular region 103 cannot be defined by a single sphere, and a centre of curvature 110 of the annular region 103 does not lie on the first optical axis 119 (as shown in FIG. 4D). The annular region 103 is radially tilted relatively to the central region 105, so that the outer edge 103′ of the annular region 103 is higher relative to its inner edge 103” than is the case in the lens 1 of FIGS. 1A and 1B. This alters the axial power of the annular region 103 but does not alter the radial curvature power of the annular region 103. As shown in FIG. 4D, the anterior surface of the central region 105 defines a portion of a surface of a sphere of larger radius 107. The anterior surface of the annular region 3 defines a curved annular surface with smaller radius 106.

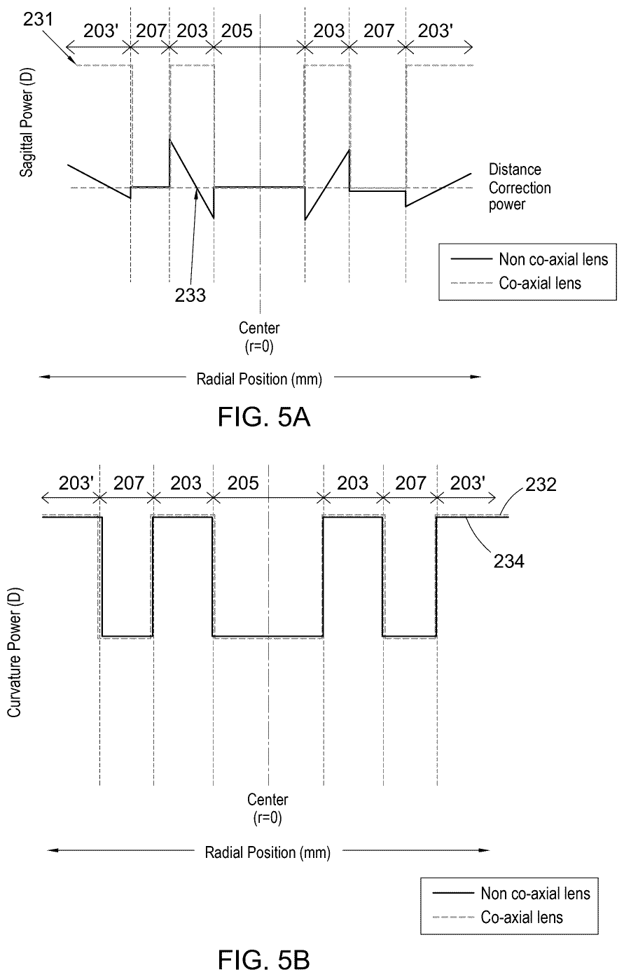

FIG. 5A shows a comparison between an axial power profile 231 (dashed line) of a lens having two co-axial, or on-axis add power annular regions spanning widths 203, 203′ (i.e., annular regions that focus light from a distant point object, on the optical axis, towards a spot on the optical axis), and an axial power profile 233 (solid line) of a lens having two non-coaxial or off-axis add power annular regions, spanning widths 203, 203′ (i.e. annular regions that do not focus light at a spot on the optical axis). FIG. 5B shows a corresponding comparison of a radial curvature profile 232 (dashed line) of a lens having two co-axial add power annular regions spanning widths 203 and 203′, and a radial curvature power profile 234 (solid line) of a lens having two non-coaxial add power annular regions spanning widths 203, 203′. The axial power and radial curvature power in Dioptres (D) is plotted as a function of radial distance from the centre of the lenses (r=0). Both lenses have a flat axial profile and radial curvature power spanning a central region 205. At the boundary of the central region 205 and the first annular region 203, for the on-axis, or co-axial lens, there is a sharp increase in the axial power 231 and a sharp increase in the radial curvature power 232; the axial power profile 231 and radial curvature power profile 232 are constant across the width of the annular region 203. At the boundary of the central region 205 and the annular region 203, for the non-coaxial lens, there is a sharp increase in curvature power 234, but a sharp decrease in the axial power 233. The axial power 233 increases with a constant gradient across the radial width of the annular region 203 for the non-coaxial lens, as a result of the radial tilting of the annular region relative to the central region. At a point halfway across the width of the annular region 203 for the non-coaxial lens, the axial power 233 matches the axial power 233 across the central region 205, which corresponds to the distance power of the lens in this case. Both lenses have a second annular region positioned at a greater radial distance from the centre of the lens. Both lenses have the same radial curvature power 232, 234 across both annular regions 203, 203′. For the co-axial lens, the axial power 231 across the width 203′ of the second annular region is substantially identical to the axial power 231 across the first annular region 203. For the non-coaxial lens, less axial add power is required to achieve the same radial curvature power, and so the gradient of the axial power profile 233 across the second annular region 203′ is less than the gradient across the first annular region 203. Both lenses have a distance power region 207 that has a substantially flat axial power profile 231, 233 and substantially flat radial curvature power profile 232, 234, in between the first 203 and second 203′ annular regions. The radial curvature power 232, 234 across the distance power region 207 matches the radial curvature power 232, 234 across the central region 205. The skilled person will realise that in alternative embodiments of both coaxial and non-coaxial lenses, the annular regions of each lens may have different radial curvature powers.

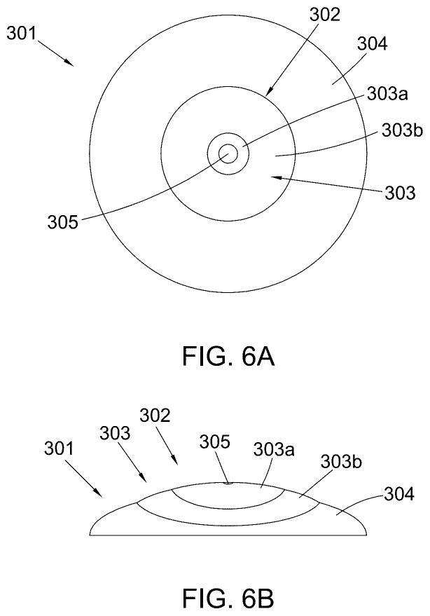

FIG. 6A shows a schematic top view of a lens 301 according to an embodiment of the present disclosure. FIG. 6B shows a schematic cross-sectional view of the lens 301 of FIG. 6A. The lens 301 comprises an optic zone 302, which approximately covers the pupil, and a peripheral zone 304 that sits over the iris. The peripheral zone 304 provides mechanical functions, including increasing the size of the lens thereby making the lens 301 easier to handle, providing ballasting to prevent rotation of the lens 301, and providing a shaped region that improves comfort for the lens 301 wearer. The optic zone 302 provides the optical functionality of the lens 301. The optic zone 302 comprises a small central region 305 having a diameter of 0.5 mm, and an annular region 303 surrounding the central region 305. The annular region 303 comprises two concentric treatment zones 303a, 303b, the inner treatment 303a being radially closer to the centre of the lens than the outer treatment one 303b. Each treatment zone 303a, 303b is radially tilted relative to the central zone 305. Each treatment zone 303a, 303b provides a radial curvature add power. For this lens 301, the radial curvature add power results from a greater curvature of the anterior surface of the lens 301. The inner treatment zone 303a, has a low radial curvature add power, and the outer treatment zone 303b has a high radial curvature add power. The outer treatment zone 303b is larger in terms of radial width than the inner treatment zone 303a.

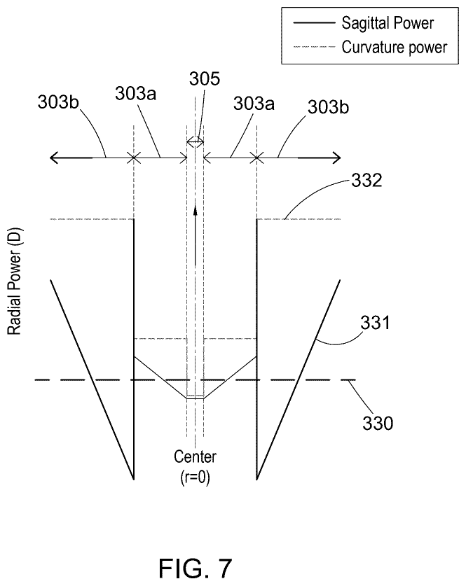

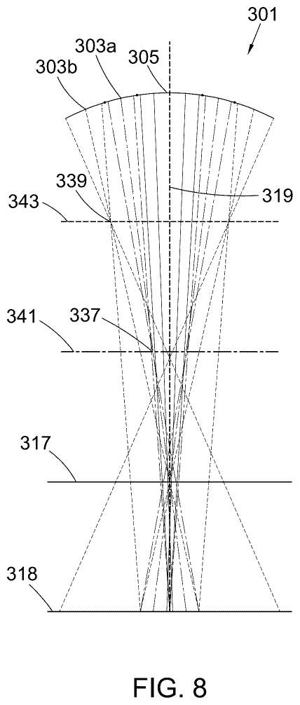

FIG. 7 shows the axial power profile 331 and the radial curvature power profile 332 taken along a radial diameter of the lens 301 shown in FIGS. 6A and 6B. Across the width of the central region 305, the axial power profile 331 is flat and has a small difference (i.e. within a margin of error) in power compared to the nominal distance power of the lens (indicated by the dashed line 330). Across the width of the central region 305, the axial power 331 is equal to the radial curvature power 332. For the lens 601 of FIGS. 6A and 6B, the axial power 331 and radial curvature power 332 across the central region 305 are more negative than the nominal distance power 330 of the lens.

At the boundary between the central zone 305 and the inner treatment zone 303a, there is an increase in radial curvature power 332. The inner treatment zone 303a has a greater curvature than the central zone 305 and therefore provides a radial add curvature power. The radial curvature power 332 is approximately constant across the width of the inner treatment zone 303a. At the boundary between the inner treatment zone 303a and the outer treatment zone 303b, there is another sharp increase in the radial curvature power 332. The outer treatment zone 303b has a greater curvature than the innermost treatment zone 303a and provides a greater radial curvature add power.

Across the inner treatment zone 303a, the axial power 331 increases with a constant positive gradient. Across the outer treatment zone 303b, the axial power 331 increases with a constant positive gradient that is substantially different to the positive gradient of the innermost treatment zone 303a. At a point halfway across the radial width of each treatment zone 303a, 303b, the axial power 331 matches the nominal distance power 330 of the lens 303. The gradient of the axial power profile 331 across the outer treatment zone 303b is greater than the gradient across the inner treatment zone 303a. The axial power does not differ from the nominal distance power, at any point of the axial power profiles 331 of both of the treatment zones 303a, 303b by more than a tolerance of ±1 D. It can be seen that the power profile of each of the treatment zones 303a, 303b varies about the nominal distance power 330 of the lens, such that, at the radially innermost part of each treatment zone 303a, 303b, the axial power is below of the nominal distance power 330, and at the radially outermost part of each treatment zone 303a, 303b, the axial power 331 is above of the nominal distance power 330.

FIG. 8 is a schematic on axis partial ray diagram (not to scale) showing how the treatment zones 303a, 303b of the lens 301 of FIGS. 6A and 6B focus light when the lens 301 is positioned on the eye (FIG. 8 does not show the different radial widths of the treatment zones 303a, 303b because of its schematic nature). Light from a distant point object, on the optical axis, passing through the small central zone 305 is focused towards a spot on the optical axis 319 at a central zone focal surface 318. The inner treatment zone 303a and outer treatment zone 303b are both radially tilted relative to the central zone 305, and therefore light from a distant point object, on the optical axis, passing through the treatment zones 303a, 303b is not focused towards a single spot on the optical axis 319. Light rays from a distant point object, on the optical axis, that pass through the radial midpoint of each treatment zone 303a, 303b converge at a convergence surface 317 that intersects the optical axis 319 and is positioned posterior to the lens 301 when the lens 301 is positioned on the eye. This convergence surface 317 is the best distal focal surface. For the lens 301 of FIGS. 6A-6B, the nominal distance power is greater than the radial curvature power of the central region 305, and therefore the best distal focal surface 317 is anterior in the eye compared to the central zone focal surface 318.

For the lens 301 shown in FIGS. 6A and 6B, each treatment zone 303a, 303b has a radial curvature power that is greater than the nominal distance power and the radial curvature power of the central region 305. Light from a distant point object, on the optical axis, that passes through the treatment zones 303a, 303b is therefore focused towards surfaces 341, 343 that are anterior in the eye compared to the best distal focal surface 317 and the central zone focal surface 318. The radial curvature power profile is approximately constant across the width of each treatment zone 303a, 303b.

The innermost radial treatment zone 303a has a lower radial curvature add power. The focal surface 341 for light rays from a distant point object, on the optical axis, passing through this treatment zone 303a is therefore shifted closer to the lens 301 than the best distal focal surface 317. This inner treatment zone 303a is radially tilted relative to the central zone 305, and light rays from a distant point object, on the optical axis, passing through this treatment zone 303a are therefore not focused towards a single spot on the optical axis 319. Instead, light rays from a distant point object, on the optical axis, passing through the innermost treatment zone 303a form an annular ring 337 at a low add focal surface 341.

The outer treatment zone 303b, which is positioned adjacent to the inner treatment zone 303a, at a greater radial distance from the optical axis 319, has a high radial curvature add power, which is greater than the radial curvature add power of the inner treatment 303a. This outer treatment zone 303b therefore focuses light from a distant point object, on the optical axis, towards a high add focal surface 343 that is closer to the lens 301 compared to the best distal focal surface 317 and compared to the low add focal surface 341. The outer treatment zone 303b is also tilted relative to the central zone 305, and so light from a distant point object, on the optical axis, passing through the outer treatment zone 303b is not focused towards a spot on the optical axis 319, but instead forms an annular ring 339 at the high add focal surface 343. The annular ring 339 formed by the outer treatment zone 303b is smaller than the annular ring 339 formed by the inner treatment zone 303a.

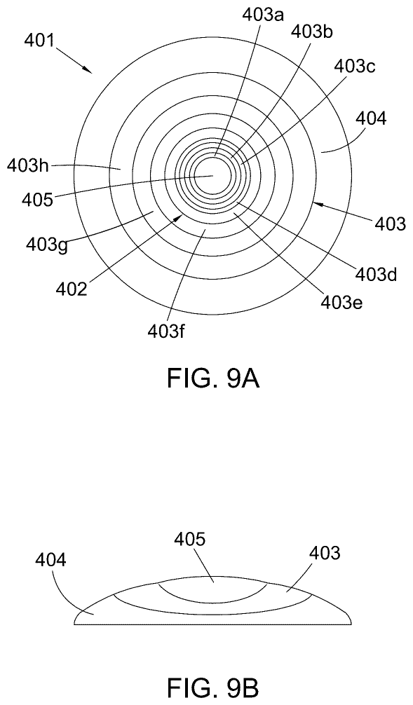

FIG. 9A shows a schematic top view of a lens 401 according to another embodiment of the present disclosure. FIG. 9B shows a schematic cross-sectional view of the lens of FIG. 9A. The lens 401 comprises an optic zone 402, which approximately covers the pupil, and a peripheral zone 404 that sits over the iris. The peripheral zone 404 provides mechanical functions, including increasing the size of the lens 401 thereby making the lens 401 easier to handle, providing ballasting to prevent rotation of the lens 401, and providing a shaped region that improves comfort for the lens 401 wearer. The optic zone 402 provides the optical functionality of the lens 401. The optic zone 402 comprises a central region 405 having a diameter of 2 mm, and an annular region 403 surrounding the central region 405. The annular region 403 comprises eight concentric treatment zones (403a, 403b, 403c, 403d, 403e, 403f, 403g, 403h, not shown in FIG. 9B for clarity reasons), each of the treatment zones having different radial widths. All of the treatment zones in the annular region 403 are radially tilted relative to the central zone 405. All of the treatment zones in the annular region 403 have a radial curvature power that is greater than the radial curvature power of the central zone 405, and greater than the nominal distance power of the lens 401. For this lens 401, all of the treatment zones in the annular region 403 provide the same radial curvature power relative to the central region 405. In the presently described embodiment of the invention, all of the treatment zones in the annular region 403 provide a radial curvature add power of +4 D.

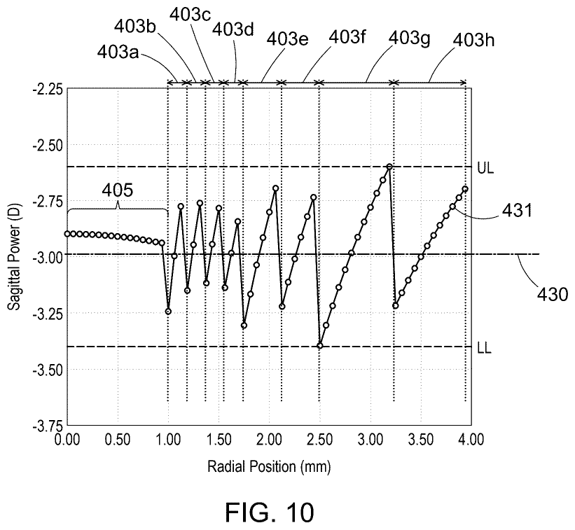

FIG. 10 shows the axial power profile 431 taken along a radial diameter of the lens 401 shown in FIGS. 9A and 9B. Across the width of the central region 405, the axial power profile 431 is substantially flat. The axial power 431 of the central region is slightly more positive than the nominal distance power, but the difference is small (e.g. within ±0.25 D) and so the central region can be considered to have the nominal distance power of the lens (indicated by the dashed line 430).

The outermost zones of the treatment zones 403g, 403h are larger than the innermost of the treatment zones 403a, 403b. The axial power does not differ from the nominal distance power ±4 D, at any point of the axial power profiles 431 of two of the treatment zones 403a, 403b by more than a tolerance of ±0.4 D. It can be seen that the power profile of each of the treatment zones 403a, 403b, 403c, 403d, 403e, 403f, 403g, 403h varies about the nominal distance power 430 of the lens, such that, at the radially innermost part of each treatment zone 403a, 403b, 403c, 403d, 403e, 403f, 403g, 403h, the axial power is below the nominal distance power 430, and at the radially outermost part of each treatment zone 403a, 403b, the axial power 431 is above of the nominal distance power 430. The gradient of the axial power profiles of each of the treatment zones 403a, 403b, 403c, 403d, 403e, 403f, 403g, 403h, is approximately linear. All of the treatment zones 403a, 403b, 403c, 403d, 403e, 403f, 403g, 403h have substantially the same radial curvature power (not shown). The curvature add power for each zone is ±4 D. Each zone has substantially the same gradient for their axial power profile.

At the boundary between the central zone 405 and the inner treatment zone 403a, there is a sharp decrease in the axial power 431, and across the inner treatment zone 403a, the axial power 431 increases with an approximately constant positive gradient. At the boundary between the inner treatment zone 403a and the outer treatment zone 403b, there is another sharp decrease in the axial power 431.

For each of the treatment zones, the axial power never differs from the nominal distance power by more than the pre-determined axial power threshold value, which in this case is a threshold value of ±0.4 D, resulting in an upper limit (UL) in axial power that can be achieved within a treatment zone, and a lower limit (LL) in axial power that can be achieved within a treatment zone. As can be seen, the second outermost treatment zone 403g has an axial power profile 431 that spans substantially the entire threshold range.

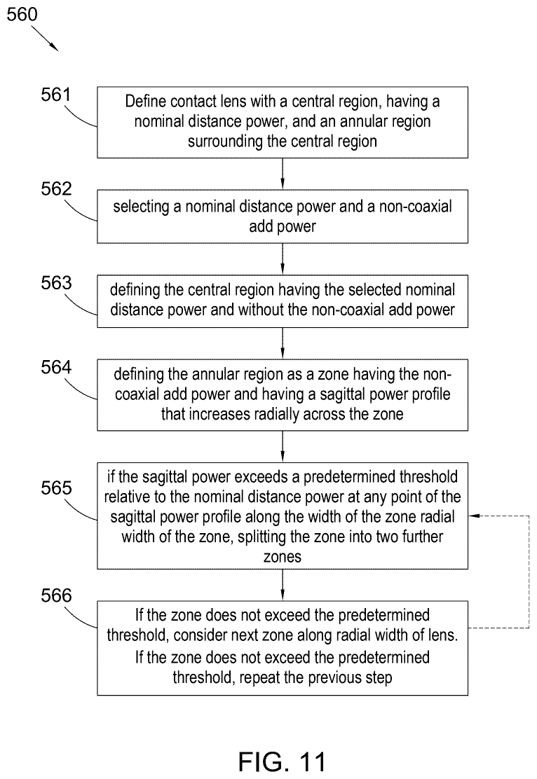

FIG. 11 is a flowchart showing a computer implemented method 560 of designing a contact lens, according to an embodiment of the present disclosure that is capable of being used to design the contact lens shown in FIG. 9. The method comprises the initial step of defining 561 a notional contact lens including an optic zone comprising a central region, the central region having a first optical axis, a centre of curvature that is on the first optical axis, wherein the central region has a nominal distance power and an annular region positioned around said central region. In a second step 562, the method comprises selecting a nominal distance power and a non-coaxial add power. In a third step 563, the method comprises defining the central region having the selected nominal distance power and without the non-coaxial add power. In a fourth step 564, the method comprises defining the annular region as a zone having the non-coaxial add power and having an axial power profile that increases radially across the zone from an axial power lower than the nominal distance power to an axial power higher than the nominal distance power. In a fifth step 565, the method comprises, in a splitting step, considering if the axial power exceeds a predetermined threshold relative to the nominal distance power at any point of the axial power profile along the width of the zone, splitting the zone into two further zones at the midpoint of the zone's radial width, each of the further zones being annular relative to the central region and concentric to each other, each of the further zones having their own axial power profile that increases radially across the zone from a axial power lower than the nominal distance power to a axial power higher than the nominal distance power. In a sixth, iterative, step 566 the method comprises repeating the fifth step, 565 for each zone until all of the zones have axial power profiles that do not exceed the predetermined threshold, by deciding that if the zone does not exceed the predetermined threshold, considering the next zone along the radial width of the lens. The iterative step 566 starts with the most radially inward zone at each iteration, so the iterative step will be repeated for the innermost zone repeatedly until the innermost zone falls within the upper and lower limit.

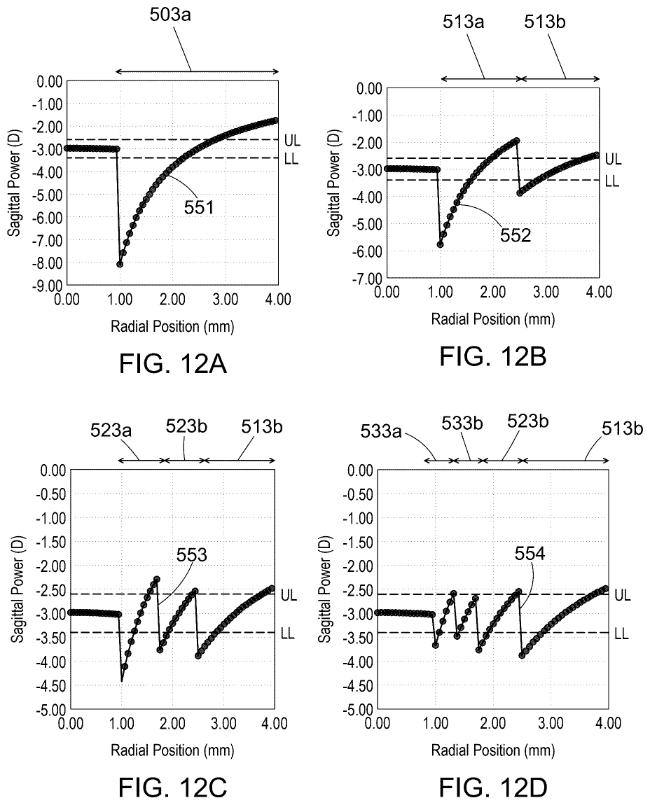

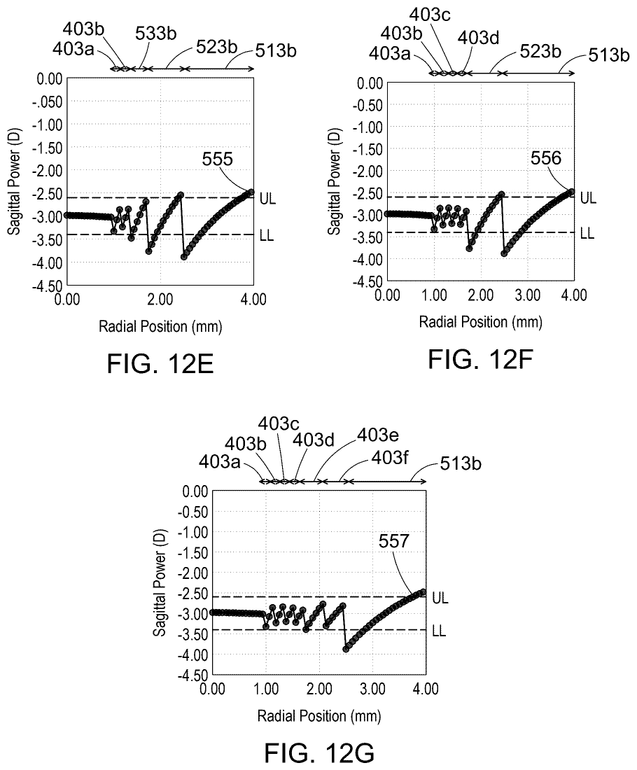

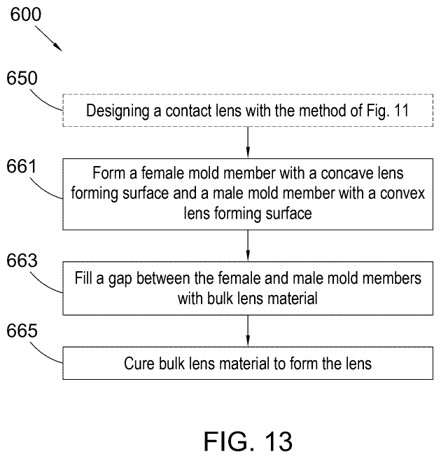

FIG. 12A to FIG. 12G show the design history of the lens of FIG. 9A, FIG. 9B and FIG. 10 as it is designed using the method described with reference to FIG. 11. FIG. 12A represents the lens after the first to fourth steps 561, 562, 563, 564, before the annular region has been split into more than one zone. The zone 503a has a radial width of 3 mm. As can be seen, the axial power profile 551 increases with a gradient roughly corresponding a gradient increasing with decreasing gradient. The axial power starts below the nominal distance power of −3 D, at approximately −8 D and thereafter increases above the nominal distance power, to a value of about −1.8 D. Thus, this zone 503a has portions of its axial power profile that fall outside the range of the upper limit (UL) −2.6 D and the lower limit (LL) −3.4 D. Therefore, the conditions of the fifth step 564 are met, and zone 503a is split radially in half into two further zones 513a, 513b, each with radial widths of 1.5 mm.

FIG. 12B represents the lens after the process described above in relation to the FIG. 12A. As can be seen, the axial power profile 552 of a first zone 513a increases across its radial width. The axial power profile 552 of the first zone 513a starts below the nominal distance power of −3 D, at approximately −5.7 D and thereafter increases above the nominal distance power, to a value of about −2 D. Thus, this zone has portions of its axial power profile that fall outside the range of the upper limit (UL) −2.6 D and the lower limit (LL) −3.4 D. Therefore, the conditions of the fifth step 564 are met, and first zone 513a is split radially in half into two further zones 523a, 523b, each with a radial width of 0.75 mm. A second zone 513b has an axial power profile 552 that falls between roughly −3.9 D and −2.5 D. Thus, it also falls outside of the upper and lower limits. However, as the method is performed with reference initially to the radially innermost zone, zone 513b is not split at this stage.

FIG. 12C represents the lens after the process described above in relation to the FIG. 12B. As can be seen, the axial power profile 553 of a first zone 523a increases across its radial width. The axial power profile 553 of the first zone 523a starts below the nominal distance power of −3 D, at approximately −4.4 D and thereafter increases above the nominal distance power, to a value of about −1.7 D. Thus, this zone has portions of its axial power profile that fall outside the range of the upper limit (UL) −2.6 D and the lower limit (LL) −3.4 D. Therefore, the conditions of the fifth step 564 are met, and first zone 523a is split radially in half into two further zones 533a, 533b each with a radial width of 0.375 mm. A second zone 523b has an axial power profile 553 that falls between roughly −3.8 D and −2.5 D. Thus, it also falls outside of the upper and lower limits. However, as the method is performed with reference initially to the radially innermost zone, zone 523b is not split at this stage. A third zone 513b remains from previous iterations of the method.

FIG. 12D represents the lens after the process described above in relation to the FIG. 12C. As can be seen, the axial power profile 554 of a first zone 533a increases across its radial width. The axial power profile 554 of the first zone 533a starts below the nominal distance power of −3 D, at approximately −3.7 D and thereafter increases above the nominal distance power, to a value of about −2.6 D. Thus, this zone has portions of its axial power profile that fall outside the range of the upper limit (UL) −2.6 D and the lower limit (LL) −3.4 D. Therefore, the conditions of the fifth step 564 are met, and first zone 533a is split radially in half into two further zones 403a, 403b each with a radial width of 0.1875 mm. A second zone 533b has an axial power profile 553 that falls between roughly −3.5 D and −2.7 D. Thus, it also falls outside of the lower limit. However, as the method is performed with reference initially to the radially innermost zone, zone 533b is not split at this stage. A third zone 523b and a fourth zone 513b remain from previous iterations of the method.

FIG. 12E represents the lens after the process described above in relation to the FIG. 12D. As can be seen, the axial power profile 555 of a first zone 403a increases across its radial width. The radial axial power profile 555 of the first zone 403a starts below the nominal distance power of −3 D, at approximately −3.3 D and thereafter increases above the nominal distance power, to a value of about −2.9 D. Thus, this zone falls entirely within the upper limit (UL) −2.6 D and the lower limit (LL) −3.4 D. A third zone 533b has an axial power profile 555 that falls between roughly −3.5 D and −2.7 D. Thus, part of this zone falls outside the upper limit (UL) −2.6 D and the lower limit (LL) −3.4 D. Therefore, the conditions of the fifth step 564 are met, and third zone 533b is split radially in half into two further zones 403c, 403d, each having a radial width of 0.1875 mm. A fourth zone 523b and a fifth zone 513b remain from previous iterations of the method.

FIG. 12F represents the lens after the process described above in relation to the FIG. 12E. As can be seen, the axial power profile 556 of a first zone 403a, second zone 403b (both previously described) third zone 403c, fourth zone 403d increases across their radial width. The radial axial power profile 556 of the third zone 403c starts below the nominal distance power of −3 D, at approximately −3.2 D and thereafter increases above the nominal distance power, to a value of about −2.9 D. Thus, this zone falls entirely within the upper limit (UL) −2.6 D and the lower limit −3.4 D (LL). The radial axial power profile 556 of the fourth zone 403d starts below the nominal distance power of −3 D, at approximately −3.2 D and thereafter increases above the nominal distance power, to a value of about −2.9 D. Thus, this zone also falls entirely within the upper limit (UL) −2.6 D and the lower limit (LL) −3.4 D. A fifth zone 523b has an axial power profile 556 that falls between roughly −3.8 D and −2.5 D. Thus, this zone has part of its radial axial power profile that falls outside the upper limit (UL) −2.6 D and the lower limit −3.4 D (LL). Therefore, the conditions of the fifth step 565 are met, and fifth zone 523b is split radially in half into two further zones 403e, 403f having a radial width of 0.375 mm. A sixth zone 513b remains from previous iterations of the method.

FIG. 12G represents the lens after the process described above in relation to the FIG. 12F. The axial power profile 557 of a first zone 403a, second zone 403b (both previously described) third zone 403c, fourth zone 403d have all been previously described. The radial axial power profile 557 of the fifth zone 403e starts below the nominal distance power of −3 D, at approximately −3.4 D and thereafter increases above the nominal distance power, to a value of about −289 D. Thus, this zone falls entirely within the upper limit (UL) −2.6 D and the lower limit (LL) −3.4 D. The radial axial power profile 556 of the sixth zone 403f starts below the nominal distance power of −3 D, at approximately −3.3 D and thereafter increases above the nominal distance power, to a value of about −2.8 D across its radial width. Thus, this zone also falls entirely within the upper limit (UL) −2.6 D and the lower limit −3.4 D (LL). A seventh zone 513b has an axial power profile 557 that falls between roughly −3.8 D and −2.5 D, and thus part of the axial power profile of this zone falls outside the upper limit (UL) −2.6 D and the lower limit (LL) −3.4 D. Therefore, the conditions of the fifth step 565 are met, and fifth zone 523b is split radially in half into two further zones 403g, 403h each having a radial width of 0.75 mm. Thus, a contact lens design corresponding to that of FIG. 10 is arrived at.

FIG. 13 is a flowchart showing a method 600 of manufacturing a contact lens, according to an embodiment of the present disclosure, optionally comprising performing 650 the method as described with reference to FIG. 11, to design the lens prior to manufacturing it. The contact lens includes an optic zone comprising a central region, the central region having a first optical axis, a nominal distance power, a centre of curvature that is on the first optical axis, and a radial diameter that is less than or equal to 2 mm. The optic zone comprises an annular region comprising a plurality of treatment zones, wherein each treatment zone has an axial power profile that increases with increasing radial distance from the optical axis. The lens may include any of the features set out above. In a first step 661 the method comprises forming a female mold member with a concave lens forming surface and a male mold member with a convex lens forming surface. In a second step 663, the method comprises filling a gap defined by the female and male mold members with bulk lens material. In a third step 665, the method comprises curing the bulk lens material to form the lens.

In alternative embodiments of the present disclosure, the lens may be formed using a lathing process, a cast molding processes, spin cast molding processes, or lathing processes, or a combination thereof.

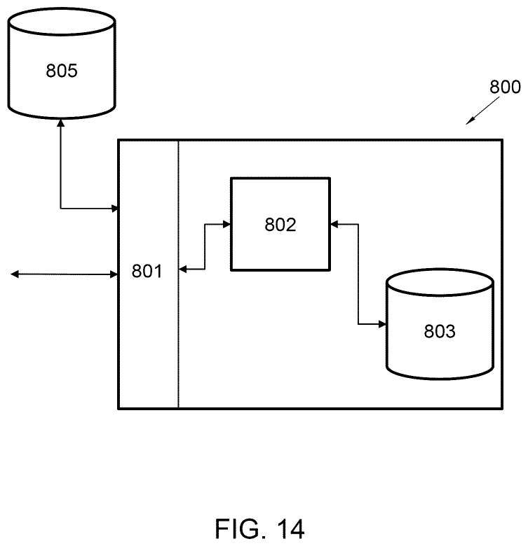

Embodiments of the disclosure include the methods described above performed on a computing device, such as the computing device 800 shown in FIG. 14. The computing device 800 comprises a data interface 801, through which data can be sent or received, for example over a network. The computing device 800 further comprises a processor 802 in communication with the data interface 801, and memory 803 in communication with the processor 802. The processor 802 can be configured to execute instructions corresponding to any of the computer implemented methods previously described, including the method of designing a contact lens. Instructions for any of the methods previously described can be stored on the memory 803. In this way, the computing device 800 can receive data, such as design input parameters (e.g. a nominal distance power and/or a non-coaxial add power, or alternatively or additionally a minimum radial zone width value), and the processor 802 can store the received data in the memory 803 and process it so as to perform the methods described herein, including methods of designing contact lenses. Contact lens designs made by instructions executed by the processor 802 can be stored on the database 805, such that they can be retrieved at a later date.

Each device, module, component, machine, or function as described in relation to any of the embodiments described herein may comprise a processor and/or processing system or may be comprised in apparatus comprising a processor and/or processing system. One or more aspects of the embodiments described herein comprise processes performed by apparatus. In some embodiments, the apparatus comprises one or more processing systems or processors configured to carry out these processes. In this regard, embodiments may be implemented at least in part by computer software stored in (non-transitory) memory and executable by the processor, or by hardware, or by a combination of tangibly stored software and hardware (and tangibly stored firmware). Embodiments also extend to computer programs and computer program products, particularly computer programs and/or computer program products on or in a carrier, adapted for putting the above-described embodiments into practice. The program may be in the form of non-transitory source code, object code, or in any other non-transitory form suitable for use in the implementation of the processes. The carrier may be any entity or device, such as a computer readable storage medium, capable of carrying the program, such as a RAM, a ROM, or an optical memory device, etc. Embodiments also extend to computer readable storage media, such as databases, that store one or more designs made by the methods, or computer programs, previously described.

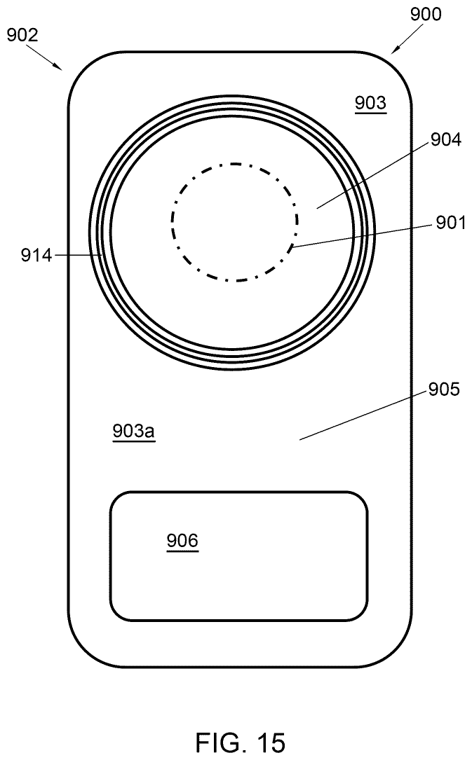

FIG. 15 shows packaged contact lens 900, wherein the contact lens 901 is packaged in a blister pack 902. The blister pack 902 comprises a plastic base 903 which appears rectangular when the upper surface is viewed in plan in FIG. 15. A bowl-like lens recess 904 when viewed in plan in FIG. 15, is formed towards a first end of the base 903, and can be seen as a roughly circular bulge in a foil lid 905 that extends over the upper surface of the blister pack and is heat sealed to the surface such that the recess 904 and lid together form a cavity in which the contact lens 901 can be stored. The contact lens 901 is not visible through the foil lid 905 and so is represented by a dashed line that denotes the location of a contact lens 901, within the recess 904. The other end of the base has a substantially flat surface region 903a. A label 906 shows the label power of the contact lens 901. The contact lens 901 has the label power. The recess 904 is in the form of a truncated circle or slope, though this cannot be seen from the present figure due to the presence of the foil lid 905. The contact lens 901 is substantially the same contact lens as shown in FIG. 9A, FIG. 9B and FIG. 10.

It will be appreciated by those of ordinary skill in the art that features of these example embodiments and/or aspects of the present disclosure may be combined in other embodiments and/or aspects of the present disclosure that fall within the scope of the present disclosure.

In the example embodiments of the present disclosure described in FIGS. 6A-14 above, the contact lenses include at least two concentric treatment zones. In other embodiments, the contact lens may include more than two concentric treatment zones. For example, the contact lens may include between two and ten concentric treatment zones. In the example embodiments of the present disclosure described in FIGS. 6A-15 above, the treatment zones all have approximately different radial widths. In other embodiments, some, but not all, of the treatment zones may have substantially the same radial width.

In the example embodiments of the present disclosure described in FIGS. 6A-14 above, the power about which the axial power varies is the nominal distance power (or the label power). However, the in other embodiment of the present disclosure, the power about which the axial power varies is a target power. The target power may be unrelated to any measured power of the central region.

In the example embodiments of the present disclosure described in FIGS. 10-12G, each of the treatment zones have substantially similar axial power profile gradients. In other embodiments, each of the treatment zones may have substantially the same axial power profile gradients. In yet further embodiments, each of the treatment zones may have different axial power profile gradients. In the example embodiments of the present disclosure described in FIGS. 10-12G, the splitting step splits the zone at its radial midpoint. In other embodiments, the splitting step may split the zone at a point different to its radial midpoint. In yet further embodiments, each of the treatment zones may be split at different relative points along their radial width (e.g. a first zone may be split at a point 25% along its radial width, whereas a second zone may be split at a point 75% along its radial width).

In the example embodiments of the present disclosure described in FIGS. 10-12G, each of the treatment zones will be subject to a splitting step if their axial power at any point across their radial width, falls outside of a predetermined threshold. In other embodiments, each of the treatment zones may have substantially the same axial power profile gradients. In yet further embodiments, each of the treatment zones may have different axial power profile gradients.

In the example embodiments of the present disclosure described with reference to FIGS. 10-12G, the radial width of each treatment zone is allowed to float freely and are no minimum radial width is imposed when deciding whether or not to split a treatment zone. However, it may be the case that a embodiments of methods of the present disclosure further comprise defining a minimum zone width, wherein, if any splitting step would cause a zone to be split to below the minimum zone width, instead of performing the splitting step, performing a step of altering the gradient of the axial power profile such that the axial power stays within the predetermined threshold across the entire radial width of the zone. Alternatively, yet further embodiments of the present disclosure may comprise defining a minimum zone width, wherein, if any splitting step would cause a zone to be split to below the minimum zone width, instead of performing the splitting step, performing a step of increasing the predetermined threshold to define an increased predetermined threshold such that the axial power stays within the increased predetermined threshold across the entire radial width of the zone.

In embodiments of the present disclosure, the coaxial regions and non-coaxial regions of the contact lens may have the same curvature power. In other embodiments, the coaxial regions and non-coaxial regions of the contact lens may each have different curvature powers.

Whilst in the foregoing description, integers or elements are mentioned which have known obvious or foreseeable equivalents, then such equivalents are herein incorporated as if individually set forth. Reference should be made to the claims for determining the true scope of the present disclosure, which should be construed as to encompass any such equivalents. It will also be appreciated by the reader that integers or features of the disclosure that are described as advantageous, convenient or the like are optional, and do not limit the scope of the independent claims. Moreover, it is to be understood that such optional integers or features, whilst of possible benefit in some embodiments of the disclosure, may not be desirable and may therefore be absent in other embodiments.

1-42. (canceled)

43. A contact lens, the lens including an optic zone comprising:
a central region, the central region having an optical axis and a curvature having a centre of curvature that is on the optical axis, wherein the central region has a nominal distance power; and
an annular region comprising a plurality of concentric treatment zones, wherein each treatment zone has a curvature that is greater than the curvature of the central region and a centre of curvature that is not on the first optical axis, thereby resulting in an axial power that varies with radius from a minimum axial power value to a maximum axial power value, wherein the axial power varies from the nominal distance power by no more than ±1 D.

44. The contact lens according to claim 43, wherein each treatment zone of the plurality of concentric treatment zones directly abuts an adjacent treatment zone of the plurality of concentric treatment zones.

45. The contact lens according to claim 43, wherein the difference between the maximum and/or minimum axial power and the nominal distance power is the same for each treatment zone.

46. The contact lens according to claim 43, wherein the difference between the maximum and/or minimum axial power and the nominal distance power is different for each treatment zone.

47. The contact lens according to claim 43, wherein at least two of the treatment zones have different radial widths.

48. The contact lens according to claim 47, wherein each treatment zone has a radial width that is different to the radial width of each of the other treatment zones.

49. The contact lens according to claim 43, wherein the average axial power is the average axial power across the radial width of the treatment zone, and wherein at least two of the treatment zones have different average axial power values.

50. The contact lens according to claim 49, each of the concentric treatment zones have different average axial power values when compared to each other.

51. The contact lens according to claim 43, the average axial power is the average axial power across the radial width of the treatment zone, and wherein and at least two of the treatment zones have substantially the same average axial power value.

52. The contact lens according to claim 51, wherein each of the concentric treatment zones have substantially the same average axial power value when compared to each other.

53. The contact lens according to claim 43, each of the plurality of concentric treatment zones has a different axial power profile.

54. The contact lens according to claim 43, wherein at a point halfway across the radial width of an innermost of the treatment zones, the axial power of that treatment zone is approximately equal to the nominal distance power of the lens.

55. A computer-implemented method of designing a contact lens, the contact lens including an optic zone comprising:
a central region, the central region having a first optical axis, a centre of curvature that is on the first optical axis, wherein the central region has a nominal distance power; and
an annular region positioned radially outer to and around said central region,
wherein the method comprises:
a. selecting a nominal distance power and a non-coaxial add power;
b. defining the central region having the selected nominal distance power and without the non-coaxial add power add power;
c. defining the annular region as a zone having the non-coaxial add power and having an axial power profile that increases radially across the zone from an axial power lower than the nominal distance power to an axial power higher than the nominal distance power;
d. determining an axial power profile along the width of the zone;
e. in a splitting step: considering if the axial power exceeds a predetermined threshold relative to the nominal distance power at any point of the axial power profile along the width of the zone, and if the axial power does exceed a predetermined threshold relative to the nominal distance power at any point of the axial power profile along the width of the zone, splitting the zone into two further zones, each of the further zones being annular relative to the central region and concentric to each other, each of the further zones having their own axial power profile that increases radially across the zone from an axial power lower than the nominal distance power to an axial power higher than the nominal distance power;
f. repeating step d. and e. for each zone until all zones have axial power profiles that do not exceed the predetermined threshold.

56. The method according to claim 55, wherein the radial splitting of the zone(s) that occurs in steps e. and f. occurs by splitting the zone(s) at a midpoint of their radial width.

57. The method according to claim 55, wherein the method further comprises defining a minimum zone width, wherein, if any splitting step would cause a zone to be split to below the minimum zone width, instead of performing the splitting step, performing a step of altering the gradient of the axial power profile such that the axial power stays within the predetermined threshold across the entire radial width of the zone.

58. The method according to claim 55, wherein the method further comprises defining a minimum zone width, wherein, if any splitting step would cause a zone to be split to below the minimum zone width, instead of performing the splitting step, performing a step of increasing the predetermined threshold to define an increased predetermined threshold, such that the axial power stays within the increased predetermined threshold across the entire radial width of the zone.

59. The method according to claim 55, further comprising the step of storing the resultant contact lens design in a database.

60. A method of manufacturing a contact lens, comprising designing a lens by the method of claim 55 and making the lens according to the design.

61. A contact lens, the lens including an optic zone comprising:
a central region, the central region having an optical axis and a curvature having a centre of curvature that is on the optical axis, and
an annular region comprising a plurality of concentric treatment zones, wherein each treatment zone has a curvature that is greater than the curvature of the central region and a centre of curvature that is not on the first optical axis, thereby resulting in an axial power that varies with radius from a minimum axial power value to a maximum axial power value, wherein the axial power varies from a power by no more than ±1 D.

62. A packaged contact lens comprising a package having a label and a contact lens within said package,
wherein the contact lens includes an optic zone comprising:
a central region, the central region having an optical axis and a curvature having a centre of curvature that is on the optical axis, and
an annular region comprising a plurality of concentric treatment zones, wherein each treatment zone has a curvature that is greater than the curvature of the central region and a centre of curvature that is not on the first optical axis, thereby resulting in an axial power that varies with radius from a minimum axial power value to a maximum axial power value, wherein the axial power varies from a label power provided on the label by no more than ±1 D.
